(19) United States
(12) Patent Application Publication
(10) Pub. No.: US 2019/0153740 A1
(43) Pub. Date: May 23, 2019

(54) PASSIVE DAMPER

(71) Applicant: UNIVERSITY OF CANTERBURY, Christchurch (NZ)

(72) Inventors: James Geoffrey CHASE, Christchurch (NZ); Geoffrey William RODGERS, Christchurch (NZ)

(21) Appl. No.: 16/090,467

(22) PCT Filed: Mar. 31, 2017
(86) PCT No.: PCT/NZ2017/050037

§ 371 Date: Oct. 1, 2018

Related U.S. Application Data
(60) Provisional application No. 62/315,992, filed on Mar. 31, 2016.

(51) Int. Cl. E04H 9/02; F16F 9/20; F16F 9/48; F16F 15/023

(52) U.S. Cl. CPC E04H 9/021; F16F 15/023; F16F 9/48; F16F 9/20

(57) ABSTRACT

A passive damper with a cylinder and piston arrangement, the cylinder being arranged to be connected to a first item, the cylinder having a first chamber and a second chamber. The piston arrangement is connected to a second item, the piston arrangement comprising a piston movable in the cylinder. A fluid passage is associated with a one-way valve. Damping fluid substantially freely flows through the fluid passage in a first direction of movement of the piston arrangement in the cylinder and the damping fluid is restricted from flowing through the fluid passage in a second direction of movement of the piston arrangement in the cylinder. Damping fluid relatively freely flows around the piston when the piston is in the second chamber of the cylinder and the damping fluid is restricted from flowing around the piston when the piston is in the first chamber of the cylinder.

### FIELD OF THE INVENTION

This invention relates to a damper for providing damping of displacement of one item relative to another item, for example during a seismic event.

### BACKGROUND

Seismic dampers may be used to absorb energy during seismic events such as earthquakes to protect a structure such as a building from structural damage. However, standard bi-directional passive dampers may provide unnecessary damping in directions of motion where it is not required, resulting in high loading and requiring stronger (and more expensive) structural members to compensate. Therefore, it is advantageous for seismic dampers to selectively provide damping only for certain directions of motion.

Dampers that selectively provide damping only for certain directions of motion may also be advantageous for other applications subject to non-seismic loads. For example in structures subject to storm loads or king tides such as off-shore platforms.

Selective damping may be achieved by utilising active or semi-active damping to apply damping only under certain conditions, for example when a structure is moving away from, or towards, its neutral position.

An active damper is one that both requires an external power source to function, and that requires a decision-making process by a control system based on real-time measured data. An active damper adds mechanical energy to the structural system in operation. In an active damper, a control system controls actuator(s) that apply forces in a prescribed manner. Active dampers are generally expensive and complex with a large number of components. They may also be susceptible to failure or limited reliability, or may be inoperable in the case of a power failure.

A semi-active damper is one that utilises a control system that is responsive to one or more sensors, to generate forces in a prescribed manner. Unlike an active damper, semi-active control systems do not add mechanical energy to the structural system. Therefore, their power consumption is generally lower than that of active dampers. However, semi-active dampers still have a significant number of components, may be susceptible to failure or limited reliability (due to communications issues between the sensor(s) and the control system for example), or may be inoperable in the case of a power failure.

It is an object of at least preferred embodiments of the present invention to provide a passive damper that allows selective damping of an item without requiring active or semi-active control and/or to at least provide the public with a useful alternative.

### SUMMARY OF THE INVENTION

In accordance with a first aspect of the present invention, there is provided a passive damper for providing damping of a first item relative to a second item, the damper comprising: a cylinder that is arranged to be operatively connected to a first item, the cylinder having a longitudinal direction and comprising a first chamber and a second chamber; a piston arrangement that is arranged to be operatively connected to a second item, the piston arrangement comprising a piston that is movable in the longitudinal direction in the cylinder; a fluid passage that is configured to allow fluid flow from one side of the piston to the other side of the piston, the fluid passage associated with a one-way valve; and damping fluid in the cylinder; wherein the fluid passage and one-way valve are configured so that damping fluid substantially freely flows through the fluid passage in a first direction of movement of the piston arrangement in the cylinder and the damping fluid is restricted from flowing through the fluid passage in a second direction of movement of the piston arrangement in the cylinder; and wherein the piston arrangement and the chambers are configured so that damping fluid relatively freely flows around the piston when the piston is in the second chamber of the cylinder and the damping fluid is restricted from flowing around the piston when the piston is in the first chamber of the cylinder.

As used herein, a ‘passive’ damper is one that does not require an external power source or control system to function. The passive damper will impart forces that are developed automatically in response to motion.

The term ‘comprising’ as used in this specification and claims means ‘consisting at least in part of’. When interpreting statements in this specification and claims which include the term ‘comprising’, other features besides the features prefaced by this term in each statement can also be present. Related terms such as ‘comprise’ and ‘comprised’ are to be interpreted in a similar manner.

In an embodiment, the damper comprises an additional fluid passage that is in fluid communication with the second chamber via two orifices, the additional fluid passage configured to provide the relatively free flow of damping fluid around the piston when the piston is in the second chamber of the cylinder. The additional fluid passage may be provided at least partly in a wall of the cylinder. In an embodiment, one orifice is located at or toward one end of the second chamber, and the other orifice is located at an opposite end of the second chamber adjacent the first chamber, with the other orifice defining an intersection between the first chamber and the second chamber. In an embodiment, the damper comprises a plurality of the additional fluid passages with orifices.

In an embodiment, the fluid passage that is configured to allow fluid flow from one side of the piston to an opposite side of the piston, is provided at least partly in a wall and/or end cap of the cylinder. Alternatively, the fluid passage that is configured to allow fluid flow from one side of the piston to an opposite side of the piston, may be provided in the piston arrangement. In an embodiment, the damper comprises a plurality of the fluid passages that are configured to allow fluid flow from one side of the piston to an opposite side of the piston.

In an embodiment, the piston arrangement and the chambers are configured so that there is less damping of movement of the piston in the second chamber than there is of movement of the piston in the first chamber. For example, damping of movement of the piston in the second chamber may be less than about ⅔, optionally less than about ½, optionally less than about ¼, or optionally any suitable reduced amount of the damping of movement of the piston in the first chamber. In an alternative embodiment, the piston arrangement and the chambers are configured so that damping fluid substantially freely flows around the piston when the piston is in the second chamber of the cylinder. In such an embodiment, there will be little or no damping of movement of the piston in the second chamber.

In an embodiment of the first aspect, the cylinder comprises a third chamber; the piston arrangement comprises a first piston coupled to a second piston to move with the second piston, wherein the first and second pistons are movable in the longitudinal direction in the cylinder, the pistons configured such that each piston can move between two chambers; the damper comprises a first fluid passage that is configured to allow fluid flow from one side of the first piston to an opposing side of the first piston, a second fluid passage that is configured to allow fluid flow from one side of the second piston to an opposing side of the second piston, and one-way valves associated with the fluid passages; wherein one of the one-way valves is configured so that the damping fluid is restricted from flowing through its associated fluid passage in a first direction of movement of the piston arrangement in the cylinder and the other of the one-way valves is configured so that the damping fluid is restricted from flowing through its associated fluid passage in the second direction of movement of the piston arrangement in the cylinder; and wherein the pistons and chambers are configured so that damping fluid relatively freely flows around the respective piston when the piston is in one chamber and the damping fluid is restricted from flowing around the respective piston when the piston is in another chamber.

In an embodiment, the piston arrangement and chambers are configured so that less damping of movement of the respective piston in said one chamber is provided than damping of movement of the respective piston in said another chamber. For example, the damping of movement of the respective piston in said one chamber may be less than about ⅔, optionally less than about ½, optionally less than about ¼, or optionally any suitable reduced amount of the damping of movement of the respective piston in said another chamber. In an alternative embodiment, the pistons and chambers are configured so that damping fluid substantially freely flows around the respective piston when the piston is in said one chamber of the cylinder. In such an embodiment, there will be little or no damping of movement of the piston in said one chamber.

In an embodiment of the first aspect, the first chamber has a first internal transverse dimension and the second chamber has a second internal transverse dimension that is larger than the first internal transverse dimension; and the fluid passage is provided in the piston arrangement and passes from one side of the piston that corresponds to a first direction of movement of the piston in the cylinder to an opposing side of the piston that corresponds to a second direction of movement of the piston in the cylinder.

In a first embodiment, the cylinder chambers and piston arrangement are configured so that damping occurs as the piston moves in a positive direction away from a neutral position of the piston in the cylinder, for at least a major part of that movement. In an embodiment, the damping occurs as the piston moves in a positive direction away from the neutral position of the piston in the cylinder, for substantially the entire movement.

In a second embodiment, the cylinder chambers and piston arrangement are configured so that damping occurs as the piston moves in a negative direction towards a neutral position of the piston in the cylinder, for at least a major part of that movement. In an embodiment, the damping occurs as the piston moves in a negative direction toward the neutral position of the piston in the cylinder, for substantially the entire movement.

In a third embodiment, the cylinder chambers and piston arrangement are configured so that damping occurs as the piston moves in a negative direction away from a neutral position of the piston in the cylinder, for at least a major part of that movement. In an embodiment, the damping occurs as the piston moves in a negative direction away from the neutral position of the piston in the cylinder, for substantially the entire movement.

In a fourth embodiment, the cylinder chambers and piston arrangement are configured so that damping occurs as the piston moves in a positive direction towards a neutral position of the piston in the cylinder, for at least a major part of that movement. In an embodiment, the damping occurs as the piston moves in a positive direction toward the neutral position of the piston in the cylinder, for substantially the entire movement.

In an embodiment, a longitudinal length of the first chamber is substantially the same as a longitudinal length of the second chamber. Alternatively, the longitudinal lengths may differ.

In an embodiment, the damper is a seismic damper.

In accordance with a second aspect of the present invention, there is provided the combination of a damper according to the first embodiment above and a damper according to the third embodiment above, the combination configured such that damping occurs in quadrant 1 and quadrant 3 of a force-displacement hysteresis loop. In an embodiment, the dampers are configured so that damping also occurs in a portion of each of quadrant 2 and quadrant 4 of the hysteresis loop, and so that less damping occurs in a remainder of each of quadrants 2 and 4. In an alternative embodiment, the dampers are configured so that less damping occurs in quadrant 2 and quadrant 4 of the hysteresis loop. In an embodiment, the dampers are configured so that little or no damping occurs in the remainder of quadrants 2 and 4 of the hysteresis loop, or so that little or no damping occurs in quadrants 2 and 4 of the hysteresis loop.

In an embodiment of the second aspect, the dampers are seismic dampers.

In accordance with a third aspect of the present invention, there is provided the combination of a damper according to the second embodiment above and a damper according to the fourth embodiment above, the combination configured such that damping occurs in quadrant 2 and quadrant 4 of a force-displacement hysteresis loop. In an embodiment, the dampers are configured so that damping also occurs in a portion of each of quadrant 1 and quadrant 3 of the hysteresis loop, and so that less damping occurs in a remainder of each of quadrants 1 and 3. In an alternative embodiment, the dampers are configured so that less damping occurs in quadrant 1 and quadrant 3 of the hysteresis loop. In an embodiment, the dampers are configured so that little or no damping occurs in the remainder of quadrants 1 and 3 of the hysteresis loop, or so that little or no damping occurs in quadrants 1 and 3 of the hysteresis loop.

In an embodiment of the third aspect, the dampers are seismic dampers.

In an embodiment of the second or third aspect above, the dampers are arranged in parallel. In an embodiment, the dampers are arranged in series. The dampers may be arranged together or co-located, or may be arranged at different ends of a brace or tendon. Two or more devices could be arranged immediately adjacent to one another, or spaced out within a structure. The devices could be arranged in any other way such that they undergo the same device input displacement.

In an embodiment, the level of damping in the two quadrants is not equal. For example, one quadrant 1 device could be connected in any suitable manner to two equal capacity quadrant 3 devices. This would create a 1-3 device with double the damping in quadrant 3 than in quadrant 1. This type of configuration may be advantageous for some non-traditional structures or off-shore applications. Alternatively, the same number of devices could be provided for the diagonally opposite quadrants, but the capacity of the devices could differ. Similar variants are possible for 2-4 configurations.

In an embodiment of the damper of the first aspect: the cylinder comprises a third chamber having a third internal transverse dimension; and the piston arrangement comprises a first piston coupled to a second piston to move with the second piston, wherein the first and second pistons are movable in the longitudinal direction in the cylinder, the pistons configured such that each piston can move between two chambers, the piston arrangement comprising a first fluid passage passing from one side of the first piston that corresponds to a first direction of movement of the first piston in the cylinder to an opposing side of the first piston that corresponds to a second direction of movement of the piston in the cylinder, a second fluid passage passing from one side of the second piston that corresponds to the first direction of movement to an opposing side of the second piston that corresponds to the second direction of movement, and one-way valves associated with the fluid passages; wherein one of the one-way valves is configured so that the damping fluid is restricted from flowing through its associated fluid passage in the first direction of movement and the other of the one-way valves is configured so that the damping fluid is restricted from flowing through its associated fluid passage in the second direction of movement; and wherein the pistons and chambers are configured so that damping fluid relatively freely flows around the respective piston when the piston is in a chamber having a larger internal dimension and the damping fluid is restricted from flowing around the respective piston when the piston is in a chamber having a smaller internal dimension.

In an embodiment, the piston arrangement and chambers are configured so that there is less damping of movement of the respective piston in said chamber having a larger internal dimension than damping of movement of the respective piston in said chamber having a smaller internal dimension. For example, the damping of movement of the respective piston in said chamber having a larger internal dimension may be less than about ⅔, optionally less than about ½, optionally less than about ¼, or optionally any suitable reduced amount of the damping of movement of the piston in said chamber having a smaller internal dimension. In an alternative embodiment, the pistons and chambers are configured so that damping fluid substantially freely flows around the respective piston when the piston is in said chamber having a larger internal dimension. In such an embodiment, there will be little or no damping of movement of the piston in said chamber having a larger internal dimension.

In an embodiment, the cylinder chambers and one-way valves are configured so that damping occurs in two diagonally opposite quadrants of a force-displacement hysteresis loop. In an embodiment, the cylinder chambers and one-way valves are configured so that damping occurs in quadrant 1 and quadrant 3 of the force-displacement hysteresis loop. In an alternative embodiment, the cylinder chambers and one-way valves are configured so that damping occurs in quadrant 2 and quadrant 4 of the force-displacement hysteresis loop.

In an embodiment, the first chamber is an inner chamber and the second and third chambers are outer chambers, and the third chamber has a larger internal transverse dimension than the internal transverse dimension of the first chamber. In an alternative embodiment, the second chamber is an inner chamber and the first and third chambers are outer chambers, and the third chamber has a smaller internal transverse dimension than the internal transverse dimension of the second chamber.

In an embodiment, the damper may provide substantially symmetrical damping properties in the first and second movement directions.

In an embodiment, the two outer chambers have substantially the same internal transverse dimension.

The fluid passage(s) associated with the first piston may have substantially the same volume as the fluid passage(s) associated with the second piston.

In an embodiment, the distance between the pistons is substantially the same as a longitudinal length of the inner chamber.

In an embodiment, a longitudinal length of the first, second and third chambers is substantially the same.

In an alternative embodiment, the damper may provide asymmetrical damping properties in the first and second directions.

In an embodiment, the two outer chambers may have different internal transverse dimensions.

The fluid passage(s) associated with the first piston may have a different volume from the fluid passage(s) associated with the second piston.

In an embodiment of the above aspects, the chambers are substantially circular in cross-section, the second chamber having a larger internal diameter than an internal diameter of the first chamber. In an embodiment, the piston is substantially circular in cross-section and has a diameter approximately the same as the diameter of the first chamber. The piston(s) and/or chambers could have any other suitable cross-sectional shape.

In an embodiment, the piston(s) is/are connected to at least one piston rod, and the fluid passage(s) is/are provided in the piston rod(s). In an embodiment, the piston rod(s) pass(es) through both ends of the cylinder.

In an alternative embodiment, the fluid passage(s) is/are located in the piston(s).

In an embodiment, the piston(s) comprise(s) a plurality of fluid passages. In an embodiment, at least some of the fluid passages are associated with one-way valve(s).

In an embodiment, the one-way valve comprises a plate configured to move between a closed position in which the plate substantially covers said at least some of the fluid passages in a piston and restricts the flow of damping fluid through the fluid passages, and an open position in which there is a gap between the fluid passages in the piston and the plate suitable to allow damping fluid to substantially freely flow through the fluid passages. In an embodiment, movement of the plate is constrained by at least one stop fastened to a raised portion of the piston.

In an embodiment, the damper comprises two pistons, each piston having an associated plate. In an embodiment, the damper comprises a plurality of one-way valves.

In an embodiment, fluid flow through at least one of the fluid passages is not restricted by the one-way valve(s).

In accordance with a fourth aspect of the present invention, there is provided a passive damper for providing damping of a first item relative to a second item, the damper comprising: a cylinder that is arranged to be operatively connected to a first item, the cylinder comprising a first chamber and a second chamber; a piston arrangement that is arranged to be operatively connected to a second item, the piston arrangement comprising a piston that is moveable in the cylinder between the first chamber and the second chamber; a fluid passage that is configured to allow fluid flow from one side of the piston to an opposite side of the piston, the fluid passage associated with a one-way valve; and damping fluid in the cylinder; wherein the damper is configured so that damping occurs in a single quadrant of a force-displacement hysteresis loop and less damping occurs in the other quadrants of the hysteresis loop, or so that damping occurs in a single quadrant of the hysteresis loop and in a portion of an adjacent quadrant of the hysteresis loop and less damping occurs in the other quadrants and in a remainder of the adjacent quadrant of the hysteresis loop.

In an embodiment, the damper is configured so that damping fluid relatively freely flows around the piston when the piston is in the second chamber of the cylinder and the damping fluid is restricted from flowing around the piston when the piston is in the first chamber of the cylinder.

In an embodiment, the damper comprises an additional fluid passage that is in fluid communication with the second chamber via two orifices, the additional fluid passage configured to provide the relatively free flow of damping fluid around the piston when the piston is in the second chamber of the cylinder. In an embodiment, one orifice is located at or toward one end of the second chamber, and the other orifice is located at an opposite end of the second chamber adjacent the first chamber, with the other orifice defining an intersection between the first chamber and the second chamber. In an embodiment, the damper comprises a plurality of the additional fluid passages with orifices.

In an embodiment, the amount of damping that occurs in the other quadrants or in the other quadrants and in the remainder of the adjacent quadrant may be less than about ⅔, optionally less than about ½, optionally less than about ¼, or optionally any suitable reduced amount of the damping that occurs in the single quadrant.

In an alternative embodiment, the damper is configured so that damping fluid substantially freely flows around the piston when the piston is in the second chamber of the cylinder. In that embodiment, little or no damping occurs in the other quadrants of the hysteresis loop or in the other quadrants and in the remainder of the adjacent quadrant of the hysteresis loop.

In an embodiment, the fluid passage that is configured to allow fluid flow from one side of the piston to an opposite side of the piston, is provided at least partly in a wall and/or end cap of the cylinder. Alternatively, the fluid passage that is configured to allow fluid flow from one side of the piston to an opposite side of the piston, may be provided in the piston arrangement. In an embodiment, the damper comprises a plurality of the fluid passages that are configured to allow fluid flow from one side of the piston to an opposite side of the piston.

The damper may have any of the configurations or features outlined in relation to the first aspect above.

The damper may be provided in combinations similar to those outlined in the second or third aspect above.

In an embodiment of the fourth aspect, the cylinder comprises an enlarged chamber and a smaller chamber; and the fluid passage is provided in the piston arrangement.

In a first embodiment, the cylinder chambers and piston arrangement are configured so that damping occurs in quadrant 1 of the hysteresis loop. In an embodiment, the cylinder chambers and piston arrangement are configured so that damping also occurs in a portion of quadrant 4 of the hysteresis loop and less damping occurs in a remainder of quadrant 4 of the hysteresis loop. In an embodiment, the cylinder chambers and piston arrangement are configured so that less damping occurs in the other three quadrants of the hysteresis loop. In an embodiment, little or no damping occurs in the remainder of quadrant 4 of the hysteresis loop, or little or no damping occurs in the other three quadrants of the hysteresis loop.

In a second embodiment, the cylinder chambers and piston arrangement are configured so that damping occurs in quadrant 2 of the hysteresis loop. In an embodiment, the cylinder chambers and piston arrangement are configured so that damping also occurs in a portion of quadrant 3 of the hysteresis loop and less damping occurs in a remainder of quadrant 3 of the hysteresis loop. In an embodiment, the cylinder chambers and piston arrangement are configured so that less damping occurs in the other three quadrants of the hysteresis loop. In an embodiment, little or no damping occurs in the remainder of quadrant 3 of the hysteresis loop, or little or no damping occurs in the other three quadrants of the hysteresis loop.

In a third embodiment, the cylinder chambers and piston arrangement are configured so that damping occurs in quadrant 3 of the hysteresis loop. In an embodiment, the cylinder chambers and piston arrangement are configured so that damping also occurs in a portion of quadrant 2 of the hysteresis loop and less damping occurs in a remainder of quadrant 2 of the hysteresis loop. In an embodiment, the cylinder chambers and piston arrangement are configured so that less damping occurs in the other three quadrants of the hysteresis loop. In an embodiment, little or no damping occurs in the remainder of quadrant 2 of the hysteresis loop, or little or no damping occurs in the other three quadrants of the hysteresis loop.

In a fourth embodiment, the cylinder chambers and piston arrangement are configured so that damping occurs in quadrant 4 of the hysteresis loop. In an embodiment, the cylinder chambers and piston arrangement are configured so that damping also occurs in a portion of quadrant 1 of the hysteresis loop and less damping occurs in a remainder of quadrant 1 of the hysteresis loop. In an embodiment, the cylinder chambers and piston arrangement are configured so that less damping occurs in the other three quadrants of the hysteresis loop. In an embodiment, little or no damping occurs in the remainder of quadrant 1 of the hysteresis loop, or little or no damping occurs in the other three quadrants of the hysteresis loop.

In an embodiment of the fourth aspect, the damper is a seismic damper.

In accordance with another aspect of the present invention, there is provided the combination of a damper according to the first embodiment of the fourth aspect above and a damper according to the third embodiment of the fourth aspect above, the combination configured such that damping occurs in quadrant 1 and quadrant 3 of a force-displacement hysteresis loop. In an embodiment, the dampers are configured so that damping also occurs in a portion of each of quadrant 2 and quadrant 4 of the hysteresis loop, and so that less damping occurs in a remainder of each of quadrants 2 and 4. In an alternative embodiment, the dampers are configured so that less damping occurs in quadrant 2 and quadrant 4 of the hysteresis loop. In an embodiment, little or no damping occurs in the remainder of each or quadrants 2 and 4, or little or no damping occurs in quadrants 2 and 4.

In accordance with another aspect of the present invention, there is provided the combination of a damper according to the second embodiment of the fourth aspect above and a damper according to the fourth embodiment of the fourth aspect above, the combination configured such that damping occurs in quadrant 2 and quadrant 4 of a force-displacement hysteresis loop. In an embodiment, the dampers are configured so that damping also occurs in a portion of each of quadrant 1 and quadrant 3 of the hysteresis loop, and so that less damping occurs in a remainder of each of quadrants 1 and 3. In an alternative embodiment, the dampers are configured so that less damping occurs in quadrant 1 and quadrant 3 of the hysteresis loop. In an embodiment, little or no damping occurs in the remainder of each or quadrants 1 and 3, or little or no damping occurs in quadrants 1 and 3.

In accordance with a fifth aspect of the present invention, there is provided a passive damper for providing damping of a first item relative to a second item, the damper comprising: a cylinder that is arranged to be operatively connected to a first item, the cylinder having a first chamber, a second chamber, and a third chamber; a first piston coupled to a second piston to move with the second piston, the first and second pistons arranged to be operatively connected to a second item, the pistons being movable in the cylinder; a first fluid passage that is configured to allow fluid flow from one side of the first piston to an opposite side of the first piston, the first fluid passage associated with a one-way valve; a second fluid passage that is configured to allow fluid flow from one side of the second piston to an opposite side of the second piston, the second fluid passage associated with a one-way valve; and damping fluid in the cylinder; wherein the damper is configured so that damping occurs in two diagonally opposite quadrants of a force-displacement hysteresis loop and less damping occurs in the other two quadrants of the hysteresis loop, or so that damping occurs in two diagonally opposite quadrants of the hysteresis loop and in a portion of each of the adjacent quadrants of the hysteresis loop and less damping occurs in a remainder of each of the adjacent quadrants of the hysteresis loop.

In an embodiment, the damper is configured so that damping fluid relatively freely flows around the first piston when the first piston is in the second chamber of the cylinder and the damping fluid is restricted from flowing around the first piston when the piston is in the first chamber of the cylinder, and is configured so that damping fluid relatively freely flows around the second piston when the second piston is in the third chamber of the cylinder and the damping fluid is restricted from flowing around the second piston when the second piston is in the first chamber.

In an embodiment, the damper comprises a first additional fluid passage that is in fluid communication with the second chamber via two orifices, the first additional fluid passage configured to provide the relatively free flow of damping fluid around the first piston when the first piston is in the second chamber of the cylinder.

In an embodiment, one orifice is located at or toward one end of the second chamber, and the other orifice is located at an opposite end of the second chamber adjacent the first chamber, with the other orifice defining an intersection between the first chamber and the second chamber.

In an embodiment, the damper comprises a second additional fluid passage that is in fluid communication with the third chamber via two orifices, the second additional fluid passage configured to provide the relatively free flow of damping fluid around the second piston when the second piston is in the third chamber of the cylinder.

In an embodiment, one orifice is located at or toward one end of the third chamber, and the other orifice is located at an opposite end of the third chamber adjacent the first chamber, with the other orifice defining an intersection between the first chamber and the third chamber.

In an embodiment, the first and second fluid passages are provided at least partly in a wall and/or an end cap of the cylinder.

In an embodiment, the first and second fluid passages are provided in the pistons.

In an embodiment, the amount of damping that occurs in the other two quadrants or in the remainder of each of the adjacent quadrants may be less than about ⅔, optionally less than about ½, optionally less than about ¼, or optionally any suitable reduced amount of the damping that occurs in the two diagonally opposite quadrants.

In an alternative embodiment, the damper is configured so that the damping fluid substantially freely flows around the first piston when the first piston is in the second chamber and so that damping fluid substantially freely flows around the second piston when the second piston is in the third chamber. In that embodiment, little or no damping occurs in the other two quadrants of the hysteresis loop or in the remainder of each of the adjacent quadrants.

In an embodiment, the first fluid passage and the second fluid passage are provided at least partly in a wall and/or an end cap of the cylinder.

In an embodiment, the first fluid passage and the second fluid passage are provided in the pistons.

In an embodiment of the fifth aspect, the first chamber has a first internal transverse dimension, the second chamber has a second internal transverse dimension, and the third chamber has a third internal transverse dimension, wherein at least one chamber has a larger internal transverse dimension than at least one other chamber; and the first fluid passage is provided in the first piston and the second fluid passage is provided in the second piston.

In an embodiment, the cylinder chambers and one-way valves are configured so that damping occurs in quadrant 1 and quadrant 3 of the hysteresis loop. In an embodiment, the cylinder chambers and piston are configured so that damping also occurs in a portion of each of quadrant 2 and quadrant 4 of the hysteresis loop, and less damping occurs in a remainder of quadrant 2 and quadrant 4 of the hysteresis loop. In an alternative embodiment, the cylinder chambers and piston are configured so that less damping occurs in quadrant 2 and quadrant 4 of the hysteresis loop. In an embodiment, little or no damping occurs in the remainder of quadrant 2 and quadrant 4 of the hysteresis loop, or little or no damping occurs in quadrant 2 and quadrant 4 of the hysteresis loop.

In an embodiment, the cylinder chambers and one-way valves are configured so that damping occurs in quadrant 2 and quadrant 4 of the hysteresis loop. In an embodiment, the cylinder chambers and piston are configured so that damping also occurs in a portion of each of quadrant 1 and quadrant 3 of the hysteresis loop, and less damping occurs in a remainder of quadrant 1 and quadrant 3 of the hysteresis loop. In an alternative embodiment, the cylinder chambers and piston are configured so that less damping occurs in quadrant 1 and quadrant 3 of the hysteresis loop. In an embodiment, little or no damping occurs in the remainder of quadrant 1 and quadrant 3 of the hysteresis loop, or little or no damping occurs in quadrant 1 and quadrant 3 of the hysteresis loop.

In an embodiment of the fifth aspect, the damper is a seismic damper.

Any of the above aspects of the invention may include any one or more of the features and/or functionality outlined above or herein in relation to any of the other aspects of the invention. Additionally, any of the above aspects may be provided in suitable combination(s), such as those outlined in relation to other aspects, to provide desired functionality.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

This invention may also be said broadly to consist in the parts, elements and features referred to or indicated in the specification of the application, individually or collectively, and any or all combinations of any two or more said parts, elements or features. Where specific integers are mentioned herein which have known equivalents in the art to which this invention relates, such known equivalents are deemed to be incorporated herein as if individually set forth.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

As used herein the term ‘(s)’ following a noun means the plural and/or singular form of that noun.

As used herein the term ‘and/or’ means ‘and’ or ‘or’, or where the context allows both. The invention consists in the foregoing and also envisages constructions of which the following gives examples only.

### BRIEF DESCRIPTION OF THE DRAWINGS

The present invention will now be described by way of example only and with reference to the accompanying drawings in which:

FIG. 1 schematically shows a first embodiment of a single quadrant damper and the force-displacement hysteresis loop obtained from operation of that damper, the hysteresis loop showing damping in a first quadrant (quadrant 1);

FIG. 2 schematically shows a second embodiment of a single quadrant damper and the force-displacement hysteresis loop obtained from operation of that damper, the hysteresis loop showing damping in a second quadrant (quadrant 2);

FIG. 3 schematically shows a third embodiment of a single quadrant damper and the force-displacement hysteresis loop obtained from operation of that damper, the hysteresis loop showing damping in a third quadrant (quadrant 3);

FIG. 4 schematically shows a fourth embodiment of a single quadrant damper and the force-displacement hysteresis loop obtained from operation of that damper, the hysteresis loop showing damping in a fourth quadrant (quadrant 4);

FIG. 5 is a cross-sectional view showing more detail of the first embodiment of a single quadrant seismic damper;

FIG. 6 shows an embodiment of a damper configured to provide damping in diagonally opposite quadrants of a force-displacement hysteresis loop, specifically quadrants 2 and 4 (a 2-4 damper);

FIG. 7A is a sectional view of the damper of FIG. 6, along line A-A of FIG. 6;

FIG. 7B is a detail view of detail 7B of FIG. 7A;

FIG. 8 is a partial sectional perspective view of the damper of FIG. 6;

FIG. 9 schematically shows the 2-4 damper of FIGS. 6 to 8, and shows a force-displacement hysteresis loop obtained from operation of the 2-4 damper, with the different curves in the 2-4 quadrants representing different input frequencies or velocities;

FIG. 10 schematically shows an embodiment of a damper configured to provide damping in diagonally opposite quadrants of a force-displacement hysteresis loop, specifically quadrants 1 and 3 (a 1-3 damper), and the force-displacement hysteresis loop obtained from operation of that damper, with the different curves in the 1-3 quadrants representing different input frequencies or velocities;

FIG. 11 shows an exploded view of an embodiment of a piston and one-way valve assembly for use in any of the damper described herein;

FIG. 12A schematically shows an alternative embodiment 2-4 damper;

FIG. 12B schematically shows an alternative embodiment 1-3 damper;

FIG. 13A schematically shows an alternative embodiment single quadrant passive damper for providing damping in a first quadrant of a force-displacement hysteresis loop;

FIG. 13B schematically shows an alternative embodiment single quadrant passive damper for providing damping in a second quadrant of a force-displacement hysteresis loop;

FIG. 13C schematically shows an alternative embodiment single quadrant passive damper for providing damping in a third quadrant of a force-displacement hysteresis loop;

FIG. 13D schematically shows an alternative embodiment single quadrant passive damper for providing damping in a fourth quadrant of a force-displacement hysteresis loop;

FIG. 14A schematically shows another alternative embodiment single quadrant passive damper for providing damping in a first quadrant of a force-displacement hysteresis loop;

FIG. 14B schematically shows another alternative embodiment single quadrant passive damper for providing damping in a second quadrant of a force-displacement hysteresis loop;

FIG. 14C schematically shows another alternative embodiment single quadrant passive damper for providing damping in a third quadrant of a force-displacement hysteresis loop;

FIG. 14D schematically shows another alternative embodiment single quadrant passive damper for providing damping in a fourth quadrant of a force-displacement hysteresis loop;

FIG. 15A schematically shows another alternative embodiment single quadrant passive damper for providing damping in a first quadrant of a force-displacement hysteresis loop;

FIG. 15B schematically shows another alternative embodiment single quadrant passive damper for providing damping in a second quadrant of a force-displacement hysteresis loop;

FIG. 15C schematically shows another alternative embodiment single quadrant passive damper for providing damping in a third quadrant of a force-displacement hysteresis loop;

FIG. 15D schematically shows another alternative embodiment single quadrant passive damper for providing damping in a fourth quadrant of a force-displacement hysteresis loop;

FIG. 16A schematically shows another alternative embodiment 2-4 damper;

FIG. 16B schematically shows another alternative embodiment 1-3 damper;

FIG. 17A schematically shows another alternative embodiment 2-4 damper;

FIG. 17B schematically shows another alternative embodiment 1-3 damper; and

FIG. 18 is a sectional perspective view of an alternative cylinder for use in one of the dampers.

### DETAILED DESCRIPTION OF PREFERRED EMBODIMENTS

The preferred embodiment devices fall into two main categories; single quadrant devices and diagonally opposed quadrant devices. A single quadrant device provides the major part of its damping in one quadrant of the device, optionally with that major damping extending to a portion of an adjacent quadrant. The single quadrant device may have less damping in the other quadrants (or in the other quadrants and a remainder of the adjacent quadrant). Advantageously, the single quadrant device may have little or no damping in the other quadrants (or in the other quadrants and the remainder of the adjacent quadrant). A diagonally opposed quadrant device provides the major part of its damping in two diagonally opposed quadrants of the device, optionally with that major damping extending to a portion of the two adjacent quadrants. The diagonally opposed quadrant device may have less damping in two adjacent quadrants (or in the remainder of the two adjacent quadrants). Advantageously, the single quadrant device may have little or no damping in the two adjacent quadrants (or in the remainder of the two adjacent quadrants).

The dampers provide direction and displacement dependent damping.

The devices may be used for seismic damping or other damping applications, for example in structures subject to storm loads or king tides such as off-shore platforms. While the dampers are described with reference to seismic damping, a skilled person will appreciate that the dampers have other applications.

Preferred embodiments of the present invention provide passive dampers for providing damping of displacement of a first item relative to a second item. The dampers can be installed between any two suitable items to be damped relative to one another. For example, one or more of the dampers can be installed between a building foundation and part of a building structure, such as a wall or framework member, or between two structural or non-structural members. The dampers could be used in any suitable rocking structures or isolation systems were unidirectional dissipation for a specific sign of displacement or movement is required.

For example, in a base isolation application, a preferred embodiment damper configured to provide damping only when the structure is moving away from its neutral position will allow the building to move freely on the isolators, with some velocity dependent damping to restrict the maximum displacement of the structure, while allowing easier return with less dissipation as it moves back towards its original neutral position. Alternatively, a preferred embodiment damper that only provides damping when the structure is returning to its neutral position means that the total force transmitted to the foundation from structural and damping forces (total base shear) is not increased. Such a configuration would be particularly useful for retrofit applications.

In some applications, unidirectional damping for a specific sign is desired. For example, in rocking structures, structural connections or certain isolation systems (such as when it is desired to prevent an item in a corner from hitting walls).

The devices may also be used for other damping applications, for example in structures subject to storm loads or king tides such as off-shore platforms.

As discussed in more detail below, the devices may comprise: a cylinder that is arranged to be operatively connected to a first item, the cylinder having a longitudinal direction and comprising a first chamber and a second chamber; a piston arrangement that is arranged to be operatively connected to a second item, the piston arrangement comprising a piston that is movable in the longitudinal direction in the cylinder; a fluid passage that is configured to allow fluid flow from one side of the piston to the other side of the piston, the fluid passage associated with a one-way valve; and damping fluid in the cylinder; wherein the fluid passage and one-way valve are configured so that damping fluid substantially freely flows through the fluid passage in a first direction of movement of the piston arrangement in the cylinder and the damping fluid is restricted from flowing through the fluid passage in a second direction of movement of the piston arrangement in the cylinder; and wherein the piston arrangement and the chambers are configured so that damping fluid relatively freely flows around the piston when the piston is in the second chamber of the cylinder and the damping fluid is restricted from flowing around the piston when the piston is in the first chamber of the cylinder.

The devices may comprise: a cylinder that is arranged to be operatively connected to a first item, the cylinder having a longitudinal direction and comprising a first chamber having a first internal transverse dimension and a second chamber having a second internal transverse dimension that is larger than the first internal transverse dimension; a piston arrangement that is arranged to be operatively connected to a second item, the piston arrangement comprising a piston that is movable in the longitudinal direction in the cylinder, the piston arrangement comprising a fluid passage passing from one side of the piston that corresponds to a first direction of movement of the piston in the cylinder to an opposing side of the piston that corresponds to a second direction of movement of the piston in the cylinder, and a one one-way valve associated with the fluid passage; and damping fluid in the cylinder; wherein the fluid passage and one-way valve are configured so that damping fluid substantially freely flows through the fluid passage in the first direction of movement and the damping fluid is restricted from flowing through the fluid passage in the second direction of movement; and wherein the piston arrangement and chambers are configured so that damping fluid relatively freely flows around the piston when the piston is in the second chamber of the cylinder and the damping fluid is restricted from flowing around the piston when the piston is in the first chamber of the cylinder.

In these configurations, the piston arrangement and the chambers may be configured so that there is less damping of movement of the piston in the second chamber than there is of movement of the piston in the first chamber. For example, damping of movement of the piston in the second chamber may be less than about ⅔, optionally less than about ½, optionally less than about ¼, or optionally any suitable reduced amount of the damping of movement of the piston in the first chamber. Alternatively, the piston arrangement and the chambers may be configured so that damping fluid substantially freely flows around the piston when the piston is in the second chamber of the cylinder. In such a configuration, there will be little or no damping of movement of the piston in the second chamber.

The devices may comprise: a cylinder that is arranged to be operatively connected to a first item, the cylinder comprising a first chamber and a second chamber; a piston arrangement that is arranged to be operatively connected to a second item, the piston arrangement comprising a piston that is moveable in the cylinder between the first chamber and the second chamber; a fluid passage that is configured to allow fluid flow from one side of the piston to an opposite side of the piston, the fluid passage associated with a one-way valve; and damping fluid in the cylinder; wherein the damper is configured so that damping occurs in a single quadrant of a force-displacement hysteresis loop and less damping occurs in the other quadrants of the hysteresis loop, or so that damping occurs in a single quadrant of the hysteresis loop and in a portion of an adjacent quadrant of the hysteresis loop and less damping occurs in the other quadrants and in a remainder of the adjacent quadrant of the hysteresis loop.

The devices may comprise: a cylinder that is arranged to be operatively connected to a first item, the cylinder comprising an enlarged chamber and a smaller chamber; a piston arrangement that is arranged to be operatively connected to a second item, the piston arrangement comprising a piston that is moveable in the cylinder, the piston arrangement comprising a fluid passage that is associated with a one-way valve; and damping fluid in the cylinder; wherein the chambers and one-way valve are configured so that damping occurs in a single quadrant of a force-displacement hysteresis loop and less damping occurs in the other quadrants of the hysteresis loop, or so that damping occurs in a single quadrant of the hysteresis loop and in a portion of an adjacent quadrant of the hysteresis loop and less damping occurs in the other quadrants and in a remainder of the adjacent quadrant of the hysteresis loop.

In these configurations, the amount of damping that occurs in the other quadrants or in the other quadrants and in the remainder of the adjacent quadrant may be less than about ⅔, optionally less than about ½, optionally less than about ¼, or optionally any suitable reduced amount of the damping that occurs in the single quadrant. Alternatively, the damper may be configured so that damping fluid substantially freely flows around the piston when the piston is in the second chamber of the cylinder. In that configuration, little or no damping occurs in the other quadrants of the hysteresis loop or in the other quadrants and in the remainder of the adjacent quadrant of the hysteresis loop.

The devices may comprise: a cylinder that is arranged to be operatively connected to a first item, the cylinder having a first chamber, a second chamber, and a third chamber; a first piston coupled to a second piston to move with the second piston, the first and second pistons arranged to be operatively connected to a second item, the pistons being movable in the cylinder; a first fluid passage that is configured to allow fluid flow from one side of the first piston to an opposite side of the first piston, the first fluid passage associated with a one-way valve; a second fluid passage that is configured to allow fluid flow from one side of the second piston to an opposite side of the second piston, the second fluid passage associated with a one-way valve; and damping fluid in the cylinder; wherein the damper is configured so that damping occurs in two diagonally opposite quadrants of a force-displacement hysteresis loop and less damping occurs in the other two quadrants of the hysteresis loop, or so that damping occurs in two diagonally opposite quadrants of the hysteresis loop and in a portion of each of the adjacent quadrants of the hysteresis loop and less damping occurs in a remainder of each of the adjacent quadrants of the hysteresis loop.

The amount of damping that occurs in the other two quadrants or in the remainder of each of the adjacent quadrants may be less than about ⅔, optionally less than about ½, optionally less than about ¼, or optionally any suitable reduced amount of the damping that occurs in the two diagonally opposite quadrants. Alternatively, the damper may be configured so that the damping fluid substantially freely flows around the first piston when the first piston is in the second chamber and so that damping fluid substantially freely flows around the second piston when the second piston is in the third chamber. In that configuration, little or no damping occurs in the other two quadrants of the hysteresis loop or in the remainder of each of the adjacent quadrants.

Single Quadrant Devices

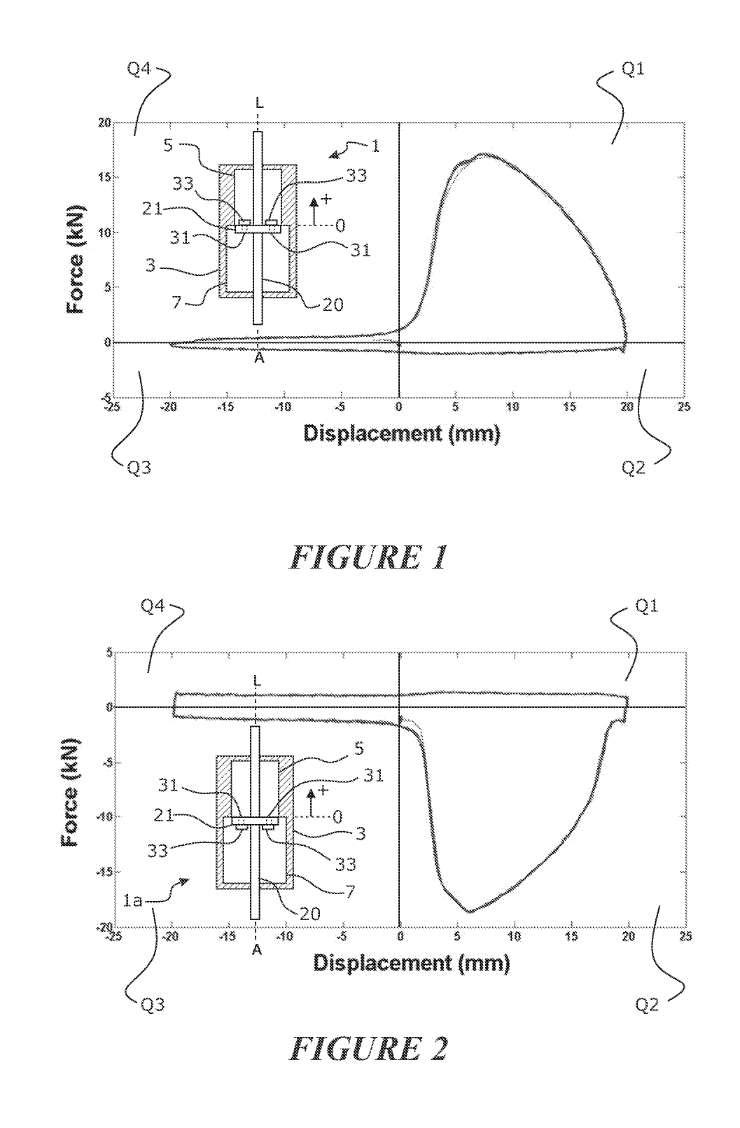

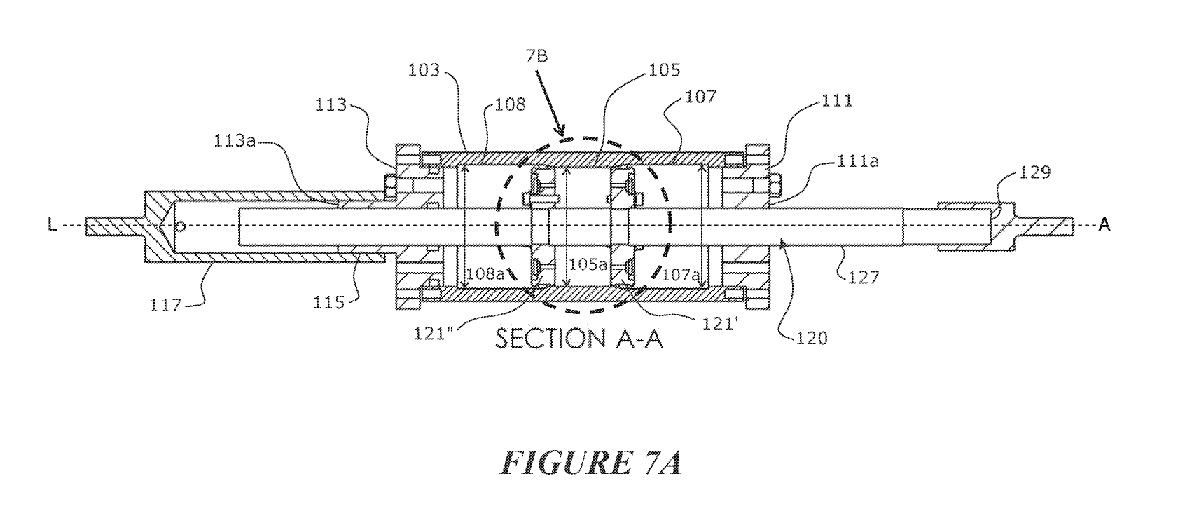

FIGS. 1 and 5 show a passive seismic damper 1 in accordance with a first embodiment. The damper comprises a cylindrical housing or cylinder 3. The cylinder defines a longitudinal axis LA that corresponds to a longitudinal direction of the cylinder. The cylinder 3 has a first chamber 5 located adjacent to a first end of the cylinder, and a second adjacent chamber 7 located adjacent to a second end of the cylinder.

The chambers 5, 7 are hollow and are configured for receipt of damping fluid. An interface region 9 is provided between the first chamber 5 and the second chamber 7. In the form shown in FIG. 5, the interface region comprises an angled linear transition region between the chambers. Alternatively, the interface region could comprise a steeper step. Alternatively, the interface region could comprise a non-linear cross-section, which may be suitable for tuning hysteresis loop behaviour of the damper.

The first chamber 5 has a first internal transverse dimension 5a that extends across the first chamber 5 and is defined by a wall of the first chamber. The second chamber 7 has a second internal transverse dimension 7a that extends across the second chamber 7 and is defined by a wall of the second chamber. The second internal transverse dimension 7a is larger than the first internal transverse dimension 5a. Therefore, the transverse cross-sectional size of the second chamber 7 is larger than that of the first chamber 5. The chambers are shown as having longitudinal lengths that are substantially the same as each other. In alternative forms, those lengths could differ.

In the form shown, the chambers 5, 7 are circular in cross-section, and the transverse internal dimensions 5a, 7a are diameters. As discussed below, a piston 21 of a piston arrangement 20 is movable back and forward in the longitudinal direction of the cylinder, in and between the first and second chambers. The piston will typically have an external shape corresponding substantially to the cross-sectional shape of the chambers. Therefore, the cross-section of the piston 21 may be circular. However, the chambers 5a, 7a and periphery of the piston could be any suitable shapes. For example, the chambers 5a, 7a and piston could be elliptical or substantially polygonal in shape. However, the second internal transverse dimension 7a will be larger than the first internal transverse dimension 5a, so that the transverse cross-sectional size of the second chamber 7 is larger than that of the first chamber 5. In some embodiments, the first chamber 5 and second chamber 7 may not have the same cross-sectional shape. The second internal transverse dimension will suitably be sufficiently larger than the first internal transverse dimension to allow free flow of fluid around the piston with minimal resistance.

The cylinder comprises end caps 11, 13 that close the ends of the cylinders. The end caps are fastened to the cylinder using suitable fasteners such as bolts for example. One of the end caps 13 comprises a boss 15 that protrudes longitudinally outwardly from the end cap, and that is fastened to a first mounting component 17. The first mounting component 17 enables the cylinder to be operatively connected to a first item that is to be damped relative to a second item. The boss and first mounting component could be operatively connected to the first item in any suitable way, such as directly or indirectly connected, and fastened by suitable fastening options such as bolts or permanent fasteners. The boss 15 and mounting component are just one suitable example, and other components or configurations could be used. The end caps are provided with apertures, one of which may be used to add damping fluid to the cylinder and the other of which may be used for a pressure sensor to monitor the device.

The piston 21 of the piston arrangement 20 is movable back and forward in the longitudinal direction of the cylinder. The piston comprises a disk-like body 23 having a periphery 25 that is approximately the same cross-sectional shape and size as that of the first chamber 5. That is, the transverse dimension of the piston is approximately the same as that of the first chamber 5. The periphery 25 of the piston has an annular recess for receipt of an O-ring seal, to provide a fluid seal between the periphery of the piston and the chamber wall when the piston is located in the first chamber 5. In one configuration, no fluid will be allowed to flow around the piston when the piston is located in the first chamber 5. Alternatively, a small amount of fluid may be able to flow around the piston.

The piston 21 and chambers 5, 7 are configured so that damping fluid substantially freely flows around the piston 21, between the periphery 25 of the piston and the wall of the chamber 7, when the piston 21 is in the second chamber 7 of the cylinder, and so that the damping fluid is restricted from flowing around the piston 21 when the piston is in the first chamber 5 of the cylinder.

At least one of the end caps 11, 13 of the cylinder has an aperture 11a, 13a that enables a piston rod 27 to pass through the end cap. The piston rod forms part of the piston arrangement 20, and moves with movement of the piston. In the form shown, the portion of the piston rod that projects from the end cap 11, comprises a second mounting component 29 that enables the piston 21 to be operatively connected to a second item that is to be damped relative to a first item. The piston rod 27 and second mounting component could be operatively connected to the second item in any suitable way, such as directly or indirectly connected, and fastened by suitable fastening options such as bolts or permanent fasteners. The piston rod 27 and second mounting component 29 are just one suitable example, and other components or configurations could be used. In the form shown, both end caps 11, 13 comprise respective apertures 11a, 13a, to allow portions of the piston rod to provide through the end caps and provide a full range of motion of the piston 21 in the cylinder 3. The piston may alternatively be coupled with two piston rods, one projecting from each side of the piston.

The piston arrangement 20 comprises at least one fluid passage 31 that passes from one side of the piston 21 that corresponds to a first direction of movement (along the longitudinal axis LA) of the piston 21 in the cylinder 3 to an opposing side of the piston 21 that corresponds to a second direction of movement (along the longitudinal axis LA) of the piston 21 in the cylinder 3. Alternatively, the piston rod(s) 27 may be hollow, and the fluid passage(s) may be provided in the piston rod(s) and extend from a position on one side of the piston that corresponds to the first direction of movement to a position on the other side of the piston that corresponds to the second direction of movement. The fluid passage(s) allow fluid to flow from one side of the piston to the other side of the piston, through the body of the piston.

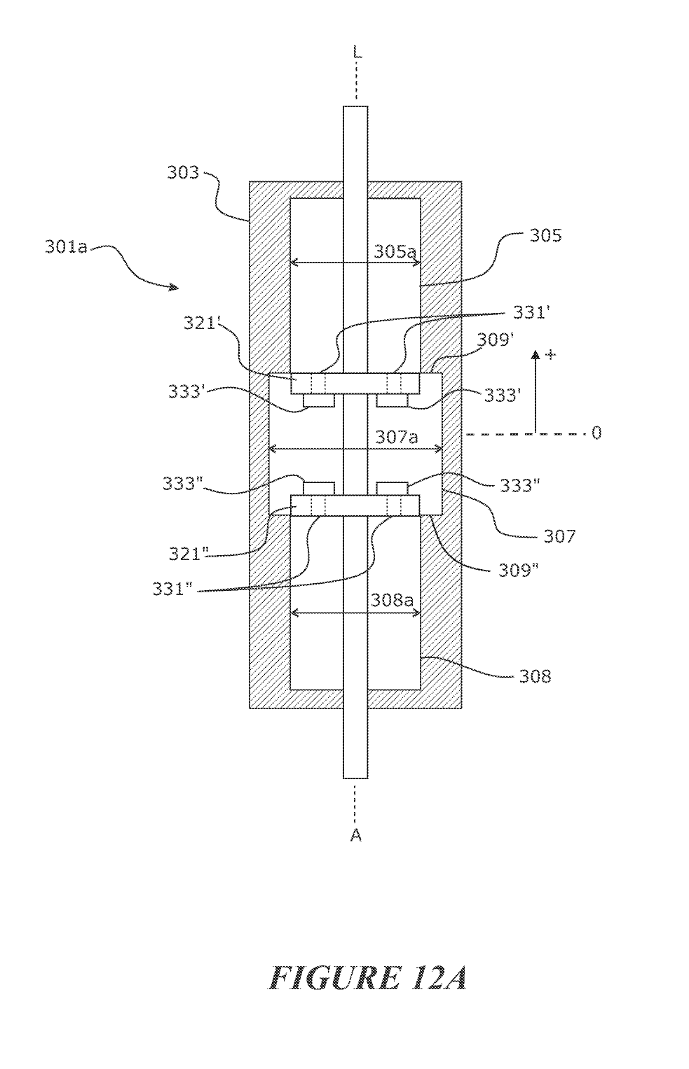

The piston arrangement 20 may comprise a single fluid passage 31 or may comprise a plurality of fluid passages 31, depending on the amount of fluid flow that is required through the fluid passage. The piston may comprise a plurality of fluid passages 31 arranged in at least one annular array in the piston body. In the form shown in FIG. 11, the piston may comprise twelve fluid passages, or may comprise fewer fluid passages (such as six fluid passages) or more fluid passages (such as eighteen or thirty fluid passages) for example. The fluid passages may be any suitable size. In one form, the fluid passages may have diameters of 3.5 mm or 4.5 mm for example. For example, the piston may comprise an outer array of a plurality of larger fluid passages and an inner array of smaller fluid passages.

The fluid passage 31 has an associated one-way valve 33. The fluid passage and the one-way valve 33 are configured so that the one-way valve is open and damping fluid substantially freely flows through the fluid passage in the first direction of movement of the piston 21 in the cylinder, and so that the one-way valve is closed and damping fluid is restricted from flowing through the fluid passage 31 in the second direction of movement of the piston in the cylinder. Suitably, no fluid will be allowed to flow through the fluid passage 31 in the second direction of movement of the piston 21 in the cylinder. Alternatively, a small amount of fluid may be able to flow through the cylinder.

The one-way valve 33 be any suitable form. The one way valve may comprise a biased disk that moves between a position in which it closes an entrance to the fluid passage 31 under a biasing force, but fluid pressure in the fluid passage will overcome the biasing force and open the one-way valve 33 when the piston moves in the first direction in the cylinder. Alternatively, the one-way valve may not be biased, and fluid pressure as the piston moves in the cylinder, will cause the one-way valve 33 to open and close. As described below with reference to FIG. 11, a single one-way valve may be provided to control flow through a plurality of fluid passages 31.

In embodiments in which the piston arrangement 20 comprises a plurality of fluid passages 31, substantially all of the fluid passages 31 may be associated with one-way valve(s) 33. For example, all of the fluid passages 31 may be associated with one-way valve(s) 33, and the piston periphery may be configured relative the first chamber wall so that a small amount of fluid may flow therebetween to enable the piston to move when the one-way valve(s) is/are closed. Alternatively, fluid flow through at least one of the fluid passages, and possibly some (but not all) of the fluid passages, may not be restricted by one-way valve(s). That is, one or some of the fluid passages may be permanently open to enable the piston to move when the one-way valve(s) is/are closed, or to reduce the level of damping provided by the damper. The fluid passage(s) that remain permanently open may be relatively small fluid passage(s), and the fluid passages(s) that are controlled by the one-way valve may be relatively large fluid passage(s).

FIG. 1 shows an exemplary force-displacement hysteresis loop from the operation of the first embodiment passive seismic damper 1. The hysteresis loop shows the damping force on the vertical axis and displacement on the horizontal axis. When the seismic damper is operatively connected to the first and second items that are to be damped relative to each other, the damper is in the neutral position shown in the left side of FIG. 1. That corresponds to the 0-0 positions on the axes of the hysteresis loop, and the piston is at the 0 position shown in the view of the damper in the left side of FIG. 1.

As will be understood by a person skilled in the art, a force-displacement hysteresis loop has four quadrants Q1, Q2, Q3, Q4. The first quadrant Q1 is the top right quadrant of the loop, above and to the right of the 0-0 position and the x and y axes. This is the quadrant of the loop corresponding to a positive displacement of the piston (in the ‘+’ direction) away from the neutral position, when the first and second items move relative to each other.

After the items have moved relative to each other a maximum positive amount, they will start returning in a negative direction towards the neutral position 0 of the damper. This corresponds to the second quadrant Q2 of the hysteresis loop, below and to the right of the 0-0 position and the x and y axes. This corresponds to a negative displacement of the piston, from the maximum positively displaced position, toward the neutral position. Generally, there will be insufficient damping of the items to stop their relative movement as they initially return to the neutral position 0 of the damper. Therefore, the items will continue in the negative direction beyond the neutral position 0 of the damper. This corresponds to the third quadrant Q3 of the hysteresis loop, below and to the left of the 0-0 position and x and y axes. This corresponds to a negative displacement of the piston, away from the neutral position.

After the items have moved relative to each other a maximum negative amount, they will start returning in a positive direction towards the neutral position 0 of the damper. This corresponds to the fourth quadrant Q4 of the hysteresis loop, above and to the left of the 0-0 position and x and y axes. This corresponds to a positive displacement of the piston, toward the neutral position.

Depending on the magnitude or duration of the seismic event, the items may continue that movement until the seismic damper has sufficiently damped the movement to bring the items to a stop.

With reference to FIG. 1, as the items undergo a positive displacement, the piston 21 moves in a positive direction away from a neutral position 0 until the piston is fully received in the first chamber 5. Because the piston is a close fit in the chamber, and the one-way valve(s) is/are closed during that movement, the damping provided by the seismic damper 1 is a maximum, as indicated by the first quadrant Q1 of FIG. 1. When the piston moves in the negative direction toward the neutral position 0, the one-way valve(s) will be open, allowing the damping fluid to substantially freely flow through the fluid passage(s) 31. Once the piston returns to the neutral position, it is located in the larger second chamber 7. When the piston is fully received in the second chamber 7, fluid substantially freely flows around the piston in both the negative and positive directions of movement in the second chamber 7. The larger second chamber 7 and periphery of the piston provide another fluid passage in the device, with that fluid passage enabling the flow of fluid around the piston when it is in the second chamber.

Depending on the relative sizes of the piston and second chamber 7, and the force of the one-way valve(s), the one-way valve(s) may be open during negative direction movement in the second chamber 7 or may be closed during that movement. The one-way valve(s) will be closed during positive movement of the piston 21 in the second chamber.

Therefore, the device 1 of FIG. 1 is a passive seismic damper that is configured so that damping occurs in a single quadrant (quadrant 1) of the force-displacement hysteresis loop, and so that little or no damping occurs in the other quadrants of the hysteresis loop.

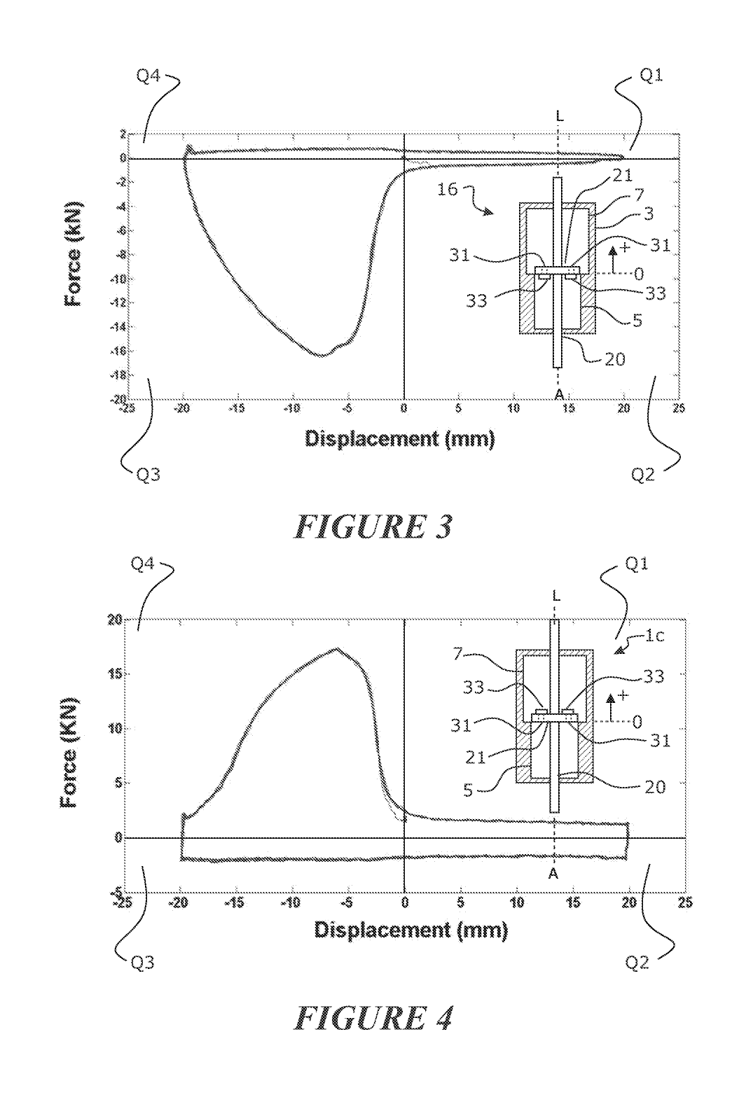

In alternative embodiments, the device may be configured to provide damping in different quadrants of the hysteresis loop, namely quadrant 2, 3, or 4. FIGS. 2, 3, and 4 show devices 1a, 1b, 1c that provide damping in quadrant 2, 3, and 4 respectively. Other than as described below, the features, functionality, and options for those devices are as described above, and like reference numerals indicate like parts.

With reference to FIG. 2, as the items undergo a positive displacement, the piston 21 of damper 1a moves in a positive direction away from a neutral position 0 until the piston is fully received in the first chamber 5. Because the piston is a close fit in the chamber, damping fluid is restricted from flowing around the piston in the chamber. However, the one-way valve(s) is/are open during that movement, allowing the damping fluid to substantially freely flow through the fluid passage(s). When the piston moves in the negative direction toward the neutral position 0, the one-way valve(s) will be closed, and the damping provided by the seismic damper 1 is a maximum, as indicated by the second quadrant Q2 of FIG. 2. Once the piston returns to the neutral position, it is located in the larger second chamber 7. When the piston is fully received in the second chamber 7, fluid substantially freely flows around the piston in both the negative and positive directions of movement in the second chamber 7. The larger second chamber 7 and periphery of the piston provide another fluid passage in the device, with that fluid passage enabling the flow of fluid around the piston when it is in the second chamber.

The one-way valve(s) will be closed during negative movement of the piston 21 in the second chamber 7. Depending on the relative sizes of the piston and second chamber 7, and the force of the one-way valve(s), the one-way valve(s) may be open during positive direction movement in the second chamber 7 or may be closed during that movement.

Therefore, the device 1a of FIG. 2 is a passive seismic damper that is configured so that damping occurs in a single quadrant (quadrant 2) of the force-displacement hysteresis loop, and so that little or no damping occurs in the other quadrants of the hysteresis loop.

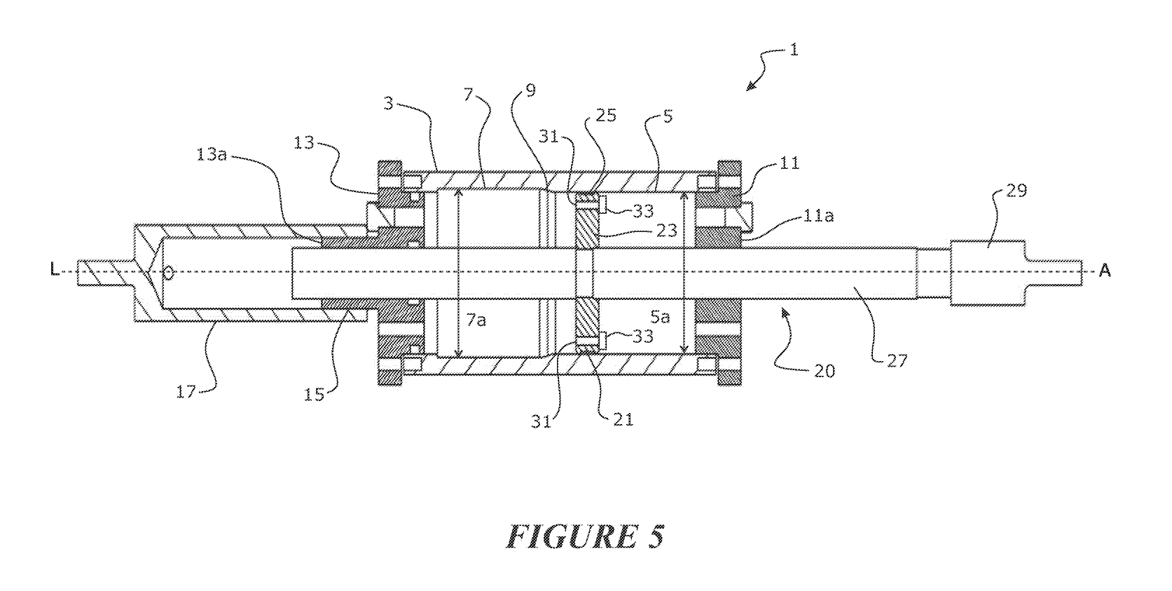

With reference to FIG. 3, as the items undergo a positive displacement, the piston 21 of damper 1b moves in a positive direction away from a neutral position 0, and the piston is fully received in the second chamber 7. When the piston is fully received in the second chamber 7, fluid substantially freely flows around the piston in both the positive and negative directions of piston movement in the second chamber 7. The larger second chamber 7 and periphery of the piston provide another fluid passage in the device, with that fluid passage enabling the flow of fluid around the piston when it is in the second chamber.

Depending on the relative sizes of the piston and second chamber 7, and the force of the one-way valve(s), the one-way valve(s) may be open during positive direction movement in the second chamber 7 or may be closed during that movement. The one-way valve(s) will be closed during negative movement of the piston 21 in the second chamber 7.

Once the piston has moved in the negative direction past the neutral position 0, the piston will be fully received in the first chamber 5. Because the piston is a close fit in the chamber 5, damping fluid is restricted from flowing around the piston in the chamber. When the piston moves in the negative direction away from the neutral position, the one-way valve(s) will be closed, and the damping provided by the seismic damper is a maximum, as indicated by the third quadrant Q3 of FIG. 3. When the piston returns in the positive direction toward the neutral position, the one-way valve(s) is/are open, allowing the damping fluid to substantially freely flow through the fluid passage(s).

Therefore, the device 1b of FIG. 3 is a passive seismic damper that is configured so that damping occurs in a single quadrant (quadrant 3) of the force-displacement hysteresis loop, and so that little or no damping occurs in the other quadrants of the hysteresis loop.

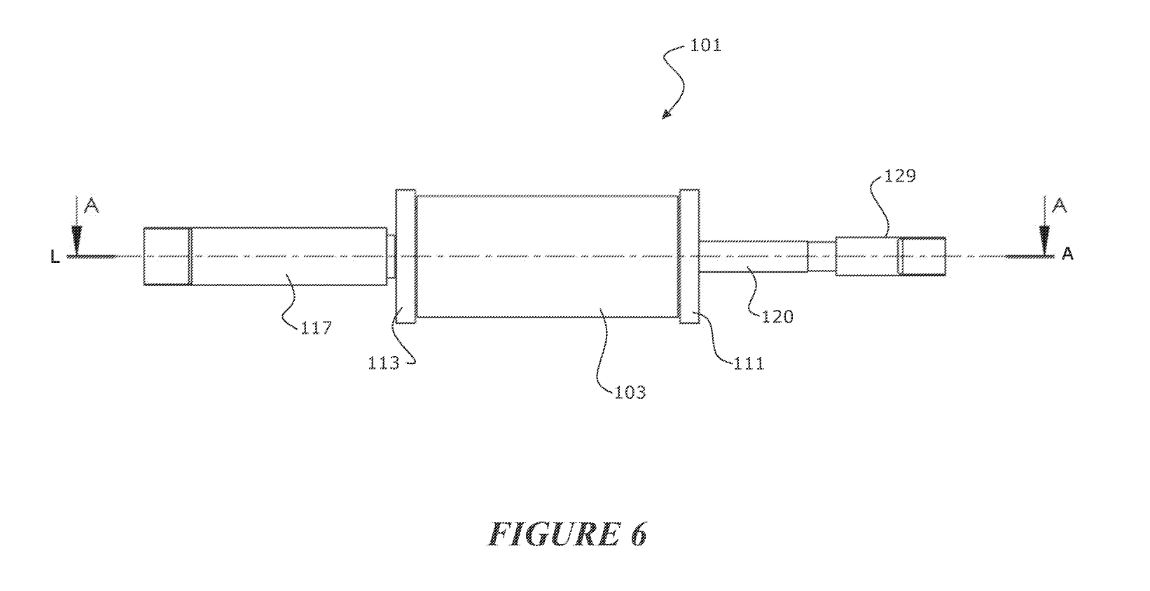

With reference to FIG. 4, as the items undergo a positive displacement, the piston 21 of damper 1c moves in a positive direction away from a neutral position 0, and the piston is fully received in the second chamber 7. When the piston is fully received in the second chamber 7, fluid substantially freely flows around the piston in both the positive and negative directions of piston movement in the second chamber 7. The larger second chamber 7 and periphery of the piston provide another fluid passage in the device, with that fluid passage enabling the flow of fluid around the piston when it is in the second chamber.

The one-way valve(s) will be closed during positive movement of the piston 21 in the second chamber 7. Depending on the relative sizes of the piston and second chamber 7, and the force of the one-way valve(s), the one-way valve(s) may be open during negative direction movement in the second chamber 7 or may be closed during that movement.

Once the piston has moved in the negative direction past the neutral position 0, the piston will be fully received in the first chamber 5. Because the piston is a close fit in the chamber 5, damping fluid is restricted from flowing around the piston in the chamber. When the piston moves in the negative direction toward the neutral position, the one-way valve(s) is/are open, allowing the damping fluid to substantially freely flow through the fluid passage(s). When the piston moves in the positive direction toward the neutral position, the one-way valve(s) will be closed, and the damping provided by the seismic damper is a maximum, as indicated by the fourth quadrant Q4 of FIG. 4.

Therefore, the device 1c of FIG. 4 is a passive seismic damper that is configured so that damping occurs in a single quadrant (quadrant 4) of the force-displacement hysteresis loop, and so that little or no damping occurs in the other quadrants of the hysteresis loop.

The hysteresis loops shown in FIGS. 1 to 4 apply where the transition region 9 is in a position corresponding to the neutral position 0 of the piston 21 in the cylinder. Alternatively, the transition region 9 may be offset in the longitudinal direction from the neutral position 0 of the piston. With such a configuration, damping may not occur for an entire quadrant of the force-displacement hysteresis loop, because there may be some distance from the neutral position in which the piston will not be located in the smaller cylinder. Additionally, or alternatively, damping may occur in a quadrant, and in a portion of an adjacent quadrant, because there may be some distance beyond the neutral position in which the piston will still be located in the smaller cylinder.

Therefore, in the first embodiment of FIG. 1, the cylinder chambers and piston arrangement may be configured so that damping occurs as the piston moves in a positive direction away from a neutral position of the piston in the cylinder, for at least a major part of that movement. Advantageously, the damping occurs as the piston moves in a positive direction away from the neutral position of the piston in the cylinder, for substantially the entire movement.

The cylinder chambers and piston arrangement may be configured so that damping also occurs in a portion of quadrant 4 of the hysteresis loop. Alternatively, the cylinder chambers and piston arrangement may be configured so that little or no damping occurs in the other three quadrants of the hysteresis loop.

In the second embodiment of FIG. 2, the cylinder chambers and piston arrangement may be configured so that damping occurs as the piston moves in a negative direction towards a neutral position of the piston in the cylinder, for at least a major part of that movement. Advantageously, the damping occurs as the piston moves in a negative direction toward the neutral position of the piston in the cylinder, for substantially the entire movement.

The cylinder chambers and piston arrangement may be configured so that damping also occurs in a portion of quadrant 3 of the hysteresis loop. Alternatively, the cylinder chambers and piston arrangement are configured so that little or no damping occurs in the other three quadrants of the hysteresis loop.

In the third embodiment of FIG. 3, the cylinder chambers and piston arrangement may be configured so that damping occurs as the piston moves in a negative direction away from a neutral position of the piston in the cylinder, for at least a major part of that movement. Advantageously, the damping occurs as the piston moves in a negative direction away from the neutral position of the piston in the cylinder, for substantially the entire movement.

The cylinder chambers and piston arrangement may be configured so that damping also occurs in a portion of quadrant 2 of the hysteresis loop. Alternatively, the cylinder chambers and piston arrangement may be configured so that little or no damping occurs in the other three quadrants of the hysteresis loop.

In the fourth embodiment of FIG. 4, the cylinder chambers and piston arrangement may be configured so that damping occurs as the piston moves in a positive direction towards a neutral position of the piston in the cylinder, for at least a major part of that movement. Advantageously, damping occurs as the piston moves in a positive direction toward the neutral position of the piston in the cylinder, for substantially the entire movement.

The cylinder chambers and piston arrangement may be configured so that damping also occurs in a portion of quadrant 1 of the hysteresis loop. Alternatively, the cylinder chambers and piston arrangement are configured so that little or no damping occurs in the other three quadrants of the hysteresis loop.

Combinations to Provide Diagonally Opposed Quadrant Devices

Any of the devices of FIGS. 1 to 5 may be installed in various combinations, to provide damping in different configurations of single quadrants.

For example, a device of FIG. 1 may be installed in parallel in combination with a device of FIG. 3, to provide damping of items in the first and third quadrants of hysteresis loops.

The seismic dampers may be configured so that damping also occurs in a portion of each of quadrant 2 and quadrant 4 of the hysteresis loop, and so that little or no damping occurs in a remainder of each of quadrants 2 and 4. Alternatively, the seismic dampers may be configured so that little or no damping occurs in quadrant 2 and quadrant 4 of the hysteresis loop.

Similarly, a device of FIG. 2 may be installed in parallel or in a different configuration in combination with a device of FIG. 4, to provide damping of items in the second and fourth quadrants of hysteresis loops.

The seismic dampers may be configured so that damping also occurs in a portion of each of quadrant 1 and quadrant 3 of the hysteresis loop, and so that little or no damping occurs in a remainder of each of quadrants 1 and 3. Alternatively, the seismic dampers are configured so that little or no damping occurs in quadrant 1 and quadrant 3 of the hysteresis loop.

The combination may provide substantially symmetrical damping properties in the first and second movement directions. Alternatively, the combination may provide asymmetrical damping properties in the first and second directions, by one damper providing a greater or lower damping force than the other damper. This could be achieved by the outer chambers of the two dampers having different proportions relative to the pistons, or by the fluid passage(s) of one damper having a different volume from the fluid passage(s) of the other damper for example. As another example, one quadrant 1 device could be connected in any suitable manner to two equal capacity quadrant 3 devices. This would create a 1-3 device with double the damping in quadrant 3 than in quadrant 1. This type of configuration may be advantageous for some non-traditional structures or off-shore applications. Alternatively, the same number of devices could be provided for the diagonally opposite quadrants, but the capacity of the devices could differ. Similar variants are possible for 2-4 configurations.

The device(s) may be installed alone, or in combination with other seismic dampers to provide desired damping properties.

It will be appreciated that a plurality of the devices may be required to provide adequate damping of an item.

Diagonally Opposed Quadrant Devices

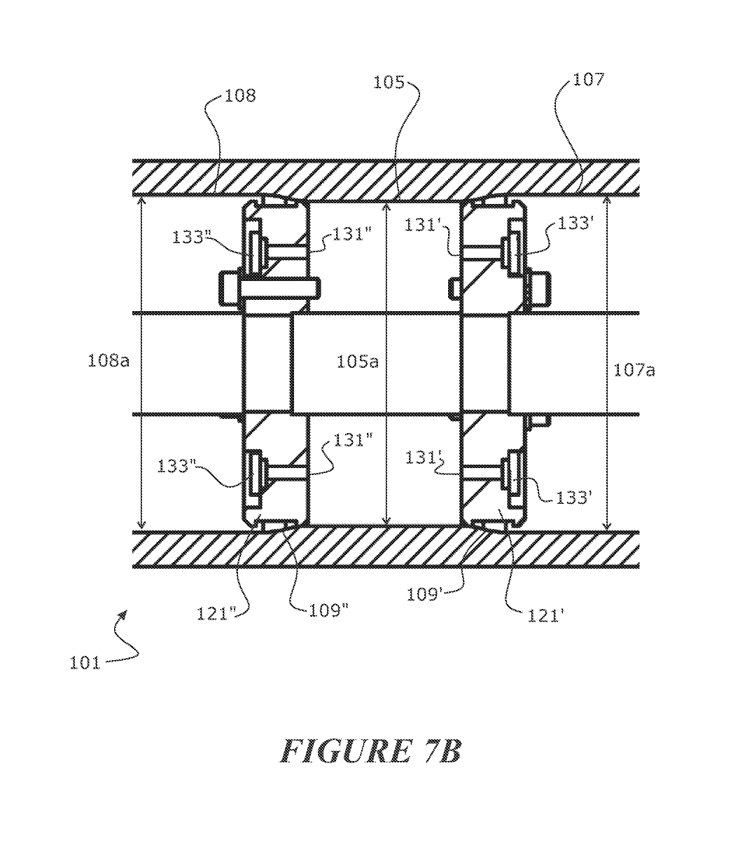

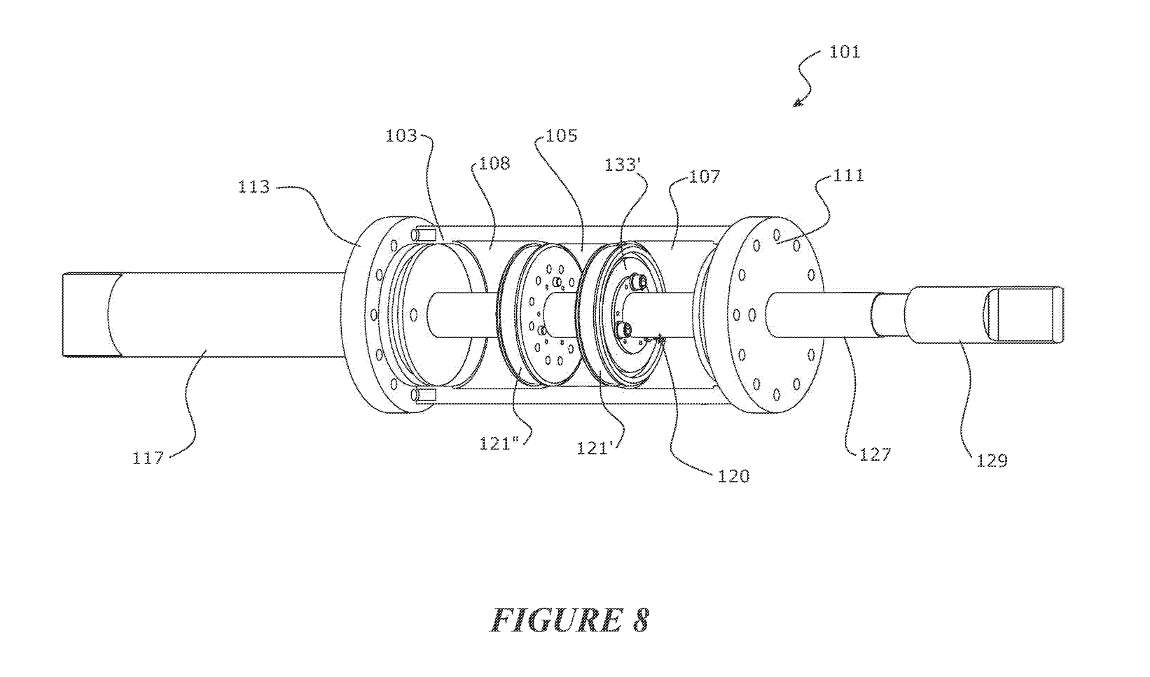

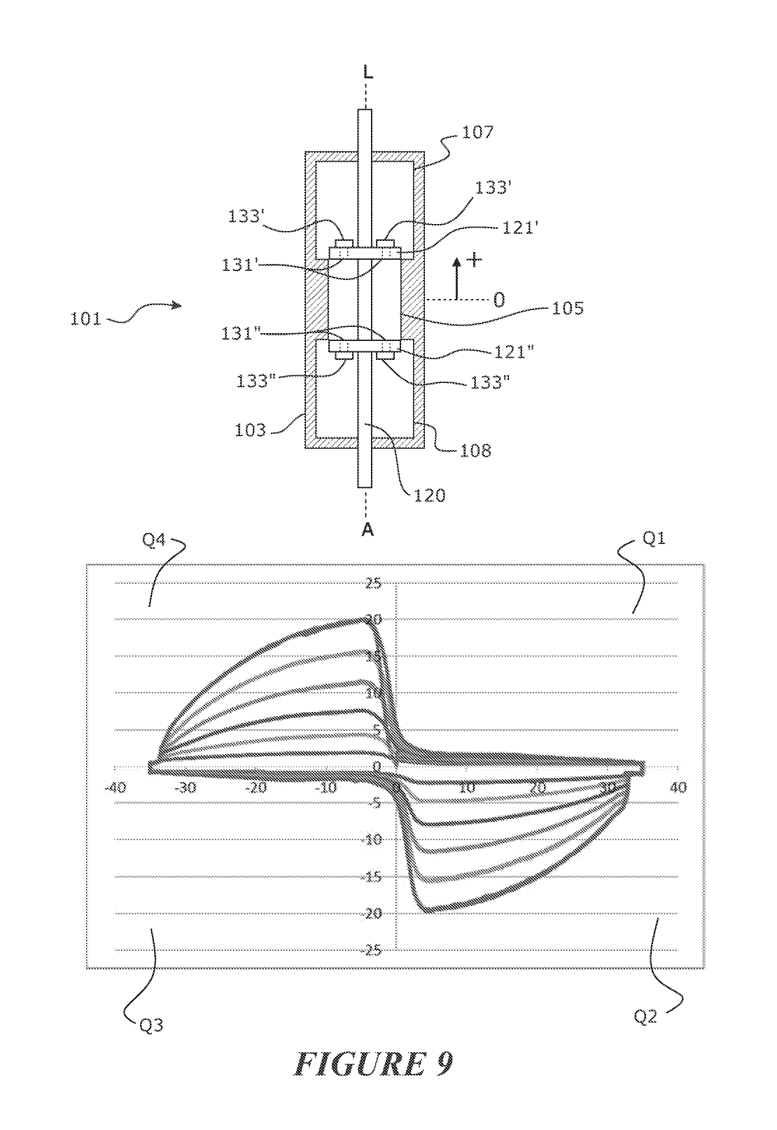

Instead of being configured as single quadrant devices, the devices could be configured to provide damping in two diagonally opposite quadrants of a hysteresis loop. Exemplary embodiments are described below and shown in FIGS. 6 to 9, 10, 12A, and 12B. Other than as described below, the features, functionality, and options for the following described embodiments are as described above, and like reference numerals indicate like parts with the addition of 100 and 200 respectively. These embodiments include two coupled pistons and associated components, and the labelling for those pistons and components includes the addition of 100 and 200 respectively, as well as prime (′) and double prime (″).

With reference to FIGS. 6 to 9, in addition to the features described above, the cylinder 103 of a preferred embodiment 2-4 device 101 comprises a third chamber 108 having a third internal transverse dimension. The third internal transverse dimension 108a is larger than the internal first transverse dimension 105a of the first chamber.

The third chamber 108 is hollow and is configured for receipt of damping fluid. An interface region 109″ is provided between the first chamber 105 and the third chamber 108. In the form shown, the interface region 109″ comprises a linear angled transition region between the chambers. Alternatively, the interface region could comprise a steeper step. Alternatively, the interface region could comprise a non-linear cross-section, which may be suitable for tuning hysteresis loop behaviour of the damper.

The third chamber 108 has a third internal transverse dimension 105a that extends across the third chamber 108 and is defined by a wall of the first chamber. The third internal transverse dimension 108a is larger than the first internal transverse dimension 105a. Therefore, the transverse cross-sectional size of the third chamber 108 is larger than that of the first chamber 105. In the form shown, the internal transverse dimensions 107a, 108a of the second and third chambers are shown as being substantially the same. In alternative forms, those chambers could differ.

The chambers 105, 107, 108 are shown as having longitudinal lengths that are substantially the same as each other. In alternative forms, those lengths could differ.

The cross-sectional shape of third chamber 108 could vary as outlined above in relation to the first and second chambers of the other embodiments.

The device of FIGS. 6 to 9 has a piston arrangement 120 with a first piston 121′ coupled to a second piston 121″, rather than the single piston 21 described for the embodiments above. The distance between the pistons is substantially the same as the longitudinal length of the first chamber 105. The pistons are shown as being coupled by a piston rod 127, but could be coupled in any suitable way to move together in the longitudinal direction of the cylinder. The pistons move together with the same displacement and at the same rate. For example, the pistons could be formed together as a single integral component. Alternatively, the piston arrangement may have a plurality of piston rods. Each piston 121′, 121″ can have any of the features outlined above in relation to the other embodiments. The pistons will typically have the same peripheral sizes and shapes so they can both engage with the wall of the first chamber 105. Alternatively, the sizes and/or shapes may differ.

The pistons 121′, 121″ have opposed one-way valves. The one-way valve(s) of the first piston 121′ is/are configured to restrict flow of damping fluid through the fluid passage(s) 131′ in a first direction of movement of the pistons in the cylinder, and to allow substantially free flow of damping fluid through the fluid passage(s) 131′ in a second direction of movement of the pistons in the cylinder. The one-way valve(s) of the second piston 121″ is/are configured to restrict flow of damping fluid through the fluid passage(s) 131″ in an opposite, second direction of movement of the pistons in the cylinder, and to allow substantially free flow of damping fluid through the fluid passage(s) 131″ in the first direction of movement of the pistons in the cylinder.

As outlined above in relation to the single quadrant devices, the fluid passage(s) could instead be provided in hollow piston rod(s), with the hollow rod(s) of the piston arrangement comprising a first fluid passage 131′ passing from one side of the first piston 121′ that corresponds to a first direction of movement of the first piston in the cylinder to an opposing side of the first piston that corresponds to a second direction of movement of the piston in the cylinder, and a second fluid passage 131″ passing from one side of the second piston 121″ that corresponds to the first direction of movement to an opposing side of the second piston that corresponds to the second direction of movement, and one-way valves associated with the fluid passages.

The pistons 121′, 121″ and cylinder are configured so that the first piston 121′ is movable between a position in which it is fully located in the smaller first chamber 105 and a position in which it is fully located in the larger second chamber 107, and so that the second piston 121″ is movable between a position in which it is fully located in the smaller first chamber 105 and a position in which it is fully located in the larger third chamber 108.

When the first piston 121′ is fully located in the second chamber 107, damping fluid substantially freely flows around the piston, and when the first piston 121′ is located in the first chamber 105, damping fluid is restricted from flowing around the piston. When the second piston 121″ is fully located in the third chamber 108, damping fluid substantially freely flows around the piston, and when the second piston 121″ is located in the first chamber 105, damping fluid is restricted from flowing around the piston. The larger second chamber 107 and periphery of the first piston 121′ provide another fluid passage in the device, with that fluid passage enabling the flow of fluid around the first piston 121′ when it is in the second chamber 107. The larger third chamber 108 and periphery of the second piston 121″ provide another fluid passage in the device, with that fluid passage enabling the flow of fluid around the second piston 121″ when it is in the third chamber 108.

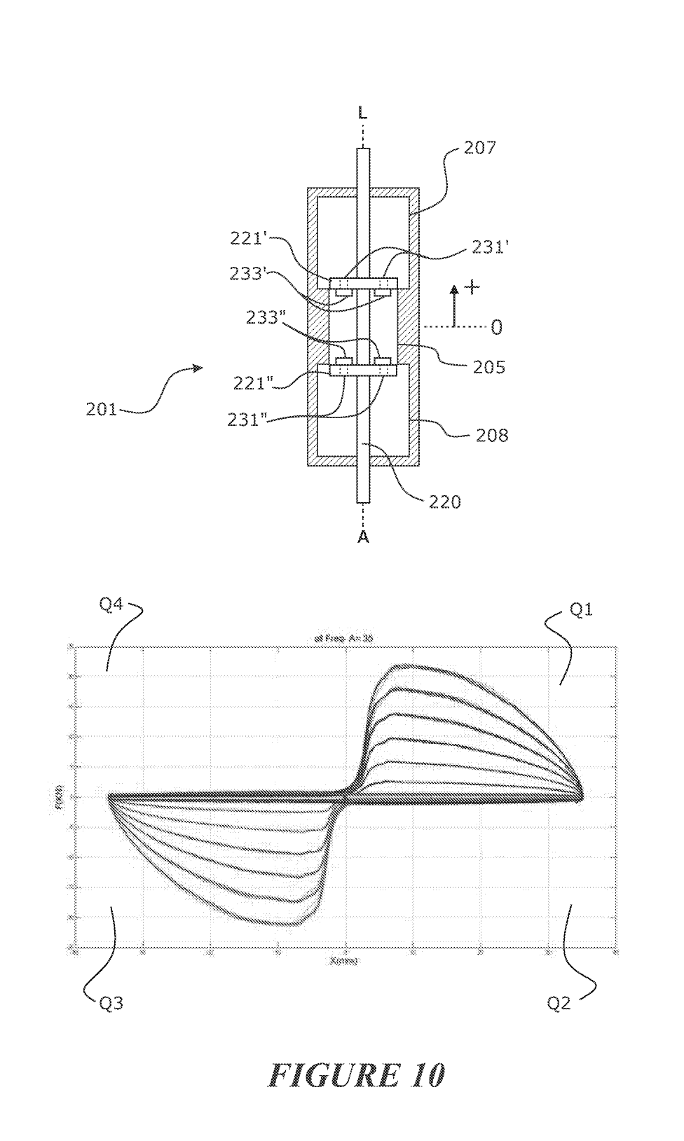

FIG. 9 shows an exemplary force-displacement hysteresis loop from the operation of the passive seismic damper 101. The hysteresis loop shows the damping force on the vertical axis and displacement on the horizontal axis. When the seismic damper is operatively connected to the first and second items that are to be damped relative to each other, the piston assembly of the damper is in the neutral position 0 shown in the upper part of FIG. 9. That corresponds to the 0-0 positions on the axes of the hysteresis loop.

With reference to FIG. 9, as the items undergo a positive displacement, the first piston 121′ moves in a positive direction until the piston is fully received in the second chamber 107. When the first piston 121′ is fully received in the second chamber 107, fluid substantially freely flows around the first piston 121′ in both the negative and positive directions of movement of the first piston 121′ in the second chamber 107. The one-way valve(s) 133′ of the first piston 121′ will be closed during that positive direction movement of the first piston.

At the same time, the coupled second piston 121″ moves in a positive direction until the second piston 121″ is fully received in the first chamber 105. Because the second piston 121″ is a close fit in the first chamber 105, fluid is restricted from flowing around the second piston 121″ when the second piston 121″ is in the first chamber. However, during that positive direction movement, the one-way valve(s) 133″ of the second piston will be open, so fluid can substantially freely flow through the fluid passage(s) 131″ of the second piston 121″.

The pistons will then move in a negative direction relative to the cylinder. Depending on the relative sizes of the first piston 121′ and second chamber 107, and the force of the one-way valve(s) 133′, the one-way valve(s) 133′ may be open during negative direction movement of the first piston 121′ in the second chamber 107 or may be closed during that movement. At the same time as the first piston 121′ moves in a negative direction toward the neutral position 0 of the piston assembly, the second piston moves in a negative direction in the first chamber 105. Because the one-way valve(s) 133″ of the second piston 121″ is/are closed during that movement, the damping provided by the seismic damper is at a maximum, as indicated by the second quadrant of FIG. 9.

The pistons will then continue to move in a negative direction relative to the cylinder until the first piston 121″ is fully received in the first chamber 105 and until the second piston 121″ is fully received in the third chamber 108. When the second piston 121″ is fully received in the third chamber 108, fluid substantially freely flows around the second piston 121″ in both the negative and positive directions of movement of the second piston 121″ in the third chamber 108. The one-way valve(s) 133″ of the second piston 121″ will be closed during that negative direction movement of the second piston.

At the same time, the coupled first piston 121′ moves in a negative direction until the first piston 121′ is fully received in the first chamber 105. Because the first piston 121′ is a close fit in the first chamber 105, fluid is restricted from flowing around the first piston 121′ when the first piston 121′ is in the first chamber. However, during that negative direction movement, the one-way valve(s) 133′ of the first piston will be open, so fluid can substantially freely flow through the fluid passage(s) 131′ of the first piston 121′.

The pistons will then move in a positive direction relative to the cylinder back towards the neutral position. Depending on the relative sizes of the second piston 121″ and third chamber 108, and the force of the one-way valve(s) 133″, the one-way valve(s) 133″ may be open during positive direction movement of the second piston 121″ in the third chamber 108 or may be closed during that movement. At the same time as the second piston 121″ moves in a positive direction toward the neutral position 0 of the piston assembly, the first piston moves in a positive direction in the first chamber 105. Because the one-way valve(s) 133′ of the first piston 121′ is/are closed during that movement, the damping provided by the seismic damper is at a maximum, as indicated by the fourth quadrant of FIG. 9.

Therefore, the device of FIGS. 6 to 9 is a passive seismic damper that is configured so that damping occurs in two diagonally opposite quadrants (quadrants 2 and 4, Q2, Q4) of the hysteresis loop, and so that little or no damping occurs in the other quadrants of the hysteresis loop.

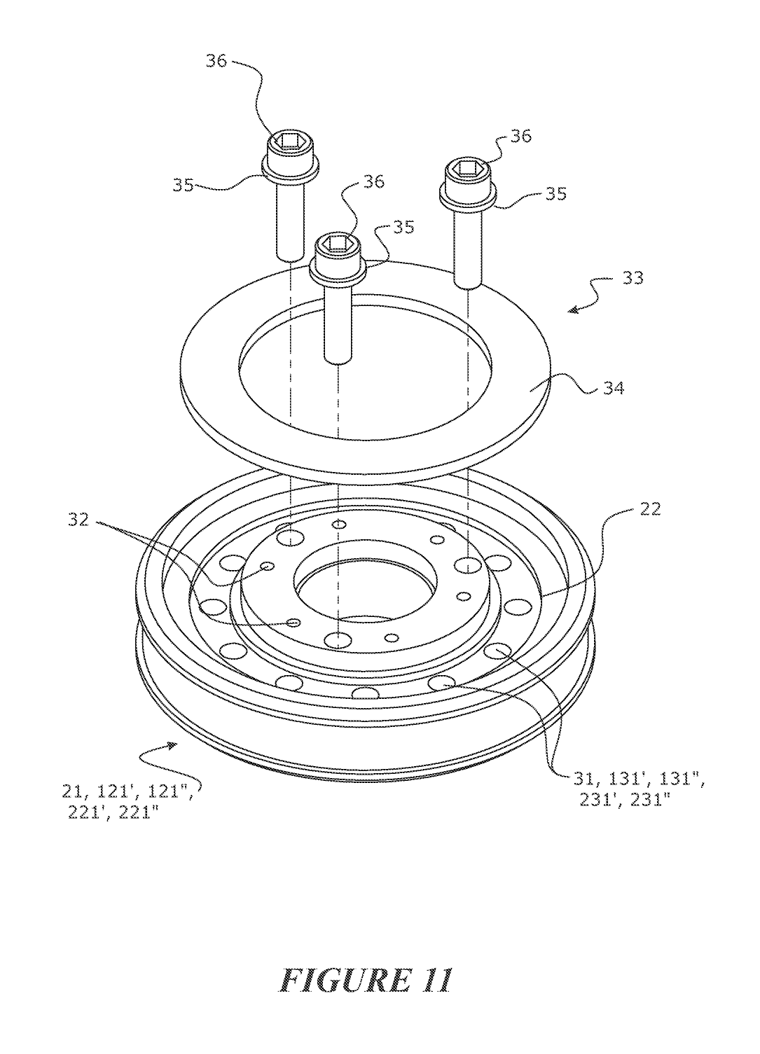

In alternative embodiments, the device may be configured to provide damping in different diagonally opposed quadrants of the hysteresis loop, namely quadrants 1 and 3, Q1, Q3. FIG. 10 shows an exemplary embodiment device that provides damping in quadrants 1 and 3.

This device differs from that of FIGS. 6 to 9 in that the orientation of the one-way valves 233′, 233″ on the first 221′ and second 221″ pistons, is reversed.

As the items undergo a positive displacement, the first piston 221′ moves in a positive direction until the piston is fully received in the second chamber 207. When the first piston 221′ is fully received in the second chamber 207, fluid substantially freely flows around the first piston 221′ in both the negative and positive directions of movement of the first piston 221′ in the second chamber 207. Depending on the relative sizes of the first piston 221′ and second chamber 207, and the force of the one-way valve(s) 233′, the one-way valve(s) 233′ may be open during positive direction movement of the first piston 221′ in the second chamber 207 or may be closed during that movement.

At the same time, the coupled second piston 221″ moves in a positive direction until the second piston 221″ is fully received in the first chamber 205. Because the second piston 221″ is a close fit in the first chamber 205, fluid is restricted from flowing around the second piston 221″ when the second piston 221″ is in the first chamber. Because the one-way valve(s) 233″ of the second piston 221″ is/are closed during that movement, the damping provided by the seismic damper is at a maximum, as indicated by the first quadrant of FIG. 10.

The pistons will then move in a negative direction relative to the cylinder. At the same time as the first piston 221′ moves in a negative direction toward the neutral position 0 of the piston assembly, the second piston moves in a negative direction in the first chamber 205. During that negative direction movement, the one-way valve(s) 233″ of the second piston will be open, so fluid can substantially freely flow through the fluid passage(s) 231″ of the second piston 221″. The one-way valves 233′ of the first piston will be closed.

The pistons will then continue to move in a negative direction relative to the cylinder until the first piston 221″ is fully received in the first chamber 205 and until the second piston 221″ is fully received in the third chamber 208. When the second piston 221″ is fully received in the third chamber 208, fluid substantially freely flows around the second piston 221″ in both the negative and positive directions of movement of the second piston 221″ in the third chamber 208. Depending on the relative sizes of the second piston 221″ and third chamber 208, and the force of the one-way valve(s) 233″, the one-way valve(s) 233″ may be open during negative direction movement of the second piston 221″ in the third chamber 208 or may be closed during that movement.

At the same time, the coupled first piston 221′ moves in a negative direction until the first piston 221′ is fully received in the first chamber 205. Because the first piston 221′ is a close fit in the first chamber 205, fluid is restricted from flowing around the first piston 221′ when the first piston 221′ is in the first chamber. Because the one-way valve(s) 233′ of the first piston 221′ is/are closed during that movement, the damping provided by the seismic damper is at a maximum, as indicated by the third quadrant of FIG. 10.

The pistons will then move in a positive direction relative to the cylinder back towards the neutral position. At the same time as the second piston 221″ moves in a positive direction toward the neutral position 0 of the piston assembly, the first piston 221′ moves in a positive direction in the first chamber 205. During that positive direction movement, the one-way valve(s) 233′ of the first piston will be open, so fluid can substantially freely flow through the fluid passage(s) 231′ of the first piston 221′. The one-way valve(s) 233″ of the second piston 221″ will be closed during that positive direction movement of the second piston.

Therefore, the device of FIG. 10 is a passive seismic damper that is configured so that damping occurs in two diagonally opposite quadrants (quadrants 1 and 3) of the hysteresis loop, and so that little or no damping occurs in the other quadrants of the hysteresis loop.

The seismic dampers of FIGS. 6-9 and 10 may provide substantially symmetrical damping properties in the first and second movement directions. For example, the pistons and larger chambers may have substantially the same internal transverse dimension, and the fluid passage(s) associated with the first piston may have substantially the same volume as the fluid passage(s) associated with the second piston.

Alternatively, the seismic dampers of FIGS. 6-9 and 10 may provide asymmetrical damping properties in the first and second directions. For example, first piston may have a first relative size compared the first larger chamber, with the second piston having a second relative size compared to the second larger chamber, with the first and second relative sizes differing from each other. Additionally, or alternatively, the fluid passage(s) associated with the first piston may have a different volume from the fluid passage(s) associated with the second piston.

The hysteresis loops shown in FIGS. 9 and 10 apply where the transition regions between chambers are in positions corresponding to the neutral position of the pistons 121′, 122″, 221′, 221″ in the cylinder. Alternatively, one or both of the transition regions may be offset in the longitudinal direction from the neutral position 0 of the pistons. With such a configuration, damping may not occur for an entire quadrant of the hysteresis loop, because there may be some distance from the neutral position in which at least one of the pistons will not be located in the smaller cylinder. Additionally, or alternatively, damping may occur in a quadrant, and in a portion of an adjacent quadrant, because there may be some distance beyond the neutral position in which at least one of the pistons will still be located in the smaller cylinder.

Therefore, for the embodiment of FIGS. 6 to 9, the cylinder chambers and piston may be configured so that damping also occurs in a portion of each of quadrant 1 and quadrant 3 of the hysteresis loop, and so that little or no damping occurs in a remainder of each of quadrants 1 and 3. In an alternative embodiment, the cylinder chambers and piston may be configured so that little or no damping occurs in quadrant 1 and quadrant 3 of the hysteresis loop.

For the embodiment of FIG. 10, the cylinder chambers and piston may be configured so that damping also occurs in a portion of each of quadrant 2 and quadrant 4 of the hysteresis loop, and so that little or no damping occurs in a remainder of each of quadrants 2 and 4. In an alternative embodiment, the cylinder chambers and piston are configured so that little or no damping occurs in quadrant 2 and quadrant 4 of the hysteresis loop.

FIG. 11 shows a one-way valve configuration that could be used for any of the pistons 21, 121′, 121″, 221′, 221″ described above.

The one-way valve 33 comprises an annular plate 34 that is configured to move between a closed position and an open position. Movement of the plate away from a surface of the piston (toward the open position of the one-way valve) is constrained by stops 35. The stops 35 are fastened to a raised portion of the piston using suitable fasteners 36 such as bolts for example.

In the closed position, the plate 34 is received in an annular recess 22 in a face of the piston, and substantially covers the fluid passages 31 in the piston 21 and restricts the flow of damping fluid through the fluid passages 31 and out of the piston. In the open position, there is a gap between the fluid passages 31 in the piston 21 and the plate 34 suitable to allow damping fluid to substantially freely flow through the fluid passages 31 and out of the piston.

In the form shown, the plate 34 is in the shape of a ring. Alternatively, the plate may be other shapes. For example, the plate may be polygonal.

In the form shown, the stops 35 are circular washers. Alternatively, the stops may be other shapes, for example larger circular washers with a portion removed to accommodate the piston rod. Alternatively, a single stop shaped to accommodate features of the piston and piston rod may be used.

In some embodiments, the plate 34 may cover all of the fluid passages 31 in the closed position. In other embodiments, the plate 34 may cover at least one of the fluid passages, and possibly some (but not all) of the fluid passages in the closed position, allowing fluid to flow through at least one of the fluid passages in the closed position.

In the form shown, the piston comprises an additional plurality of smaller fluid passages 32 that are not covered by the plate 34 in its closed position, to enable a small amount of damping fluid to flow through the piston so that the piston can move when it is in the smaller chamber.

Two opposing one-way valves 133′ and 133″ or 233′ and 233″ may be used on two pistons 121′ and 121″ or 221′ and 221″ in a diagonally opposed quadrant device. The design of these pistons enables the direction of the one-way valves on the pistons to easily be reversed, to change the quadrant(s) that the device provides the majority of its damping in.

The components can readily be manufactured from suitable materials. For example, many of the components can be made from stainless steel, with rubber or elastomeric seals.

The damping fluid used in the devices of the described embodiments could be any fluid with a suitable viscosity for the desired application. The fluid could be a liquid, a gas, or a compressed gas, for example. It has been found that regular oil (Castrol Axel EPX 80W-90 oil with a dynamic viscosity of about 0.08 N.s.m-2 was tested) can provide damping down to the 10-50 kN range, meaning that a preferred embodiment device could be used with regular oil for seismic damping of ‘light’ target structures such as isolated houses, steel framed houses, or milking sheds for example. Other examples include server equipment, oil and gas works equipment, and blast load-resistant applications. Alternatively, damping fluids with higher viscosities, and/or a greater number of devices, could be used for heavier applications such as heavier buildings, off-shore platforms, bridges, etc. The dampers could be configured to provide damping forces of between 10N and 200 kN, depending on the damping fluid and dimensions used.

A single quadrant damper configuration is useful in rocking structures or in any isolation system where unidirectional dissipation for a specific sign of displacement is desired. They may also be useful in rocking structures or connections. Two single quadrant damping devices could be used to prevent an item in a corner from hitting walls.

A 2-4 damper configuration is useful as it provides damping forces only as the structure (or other item) returns back to centre. In doing so, it only adds damping in the 2nd and 4th quadrants, when the structural force is of an opposing sign. This configuration means that the total base shear (the total force transmitted to the foundation as a result of both structural forces and the damping forces) is not increased. Essentially, it means that structural displacement reductions can be achieved without increasing the demand on the foundation, something that is important for retrofit applications.

The 1-3 damper configuration (providing large damping forces only away from the centre) can be an advantage for base isolation applications (or the isolation of any item or sub-system within a structure such as a server room or other high value facility for example). Using this configuration, the building can move freely on the isolators, with some velocity dependent damping to restrict the maximum displacement/excursion of the structure and avoid the building contacting the moat/surround of the structure.

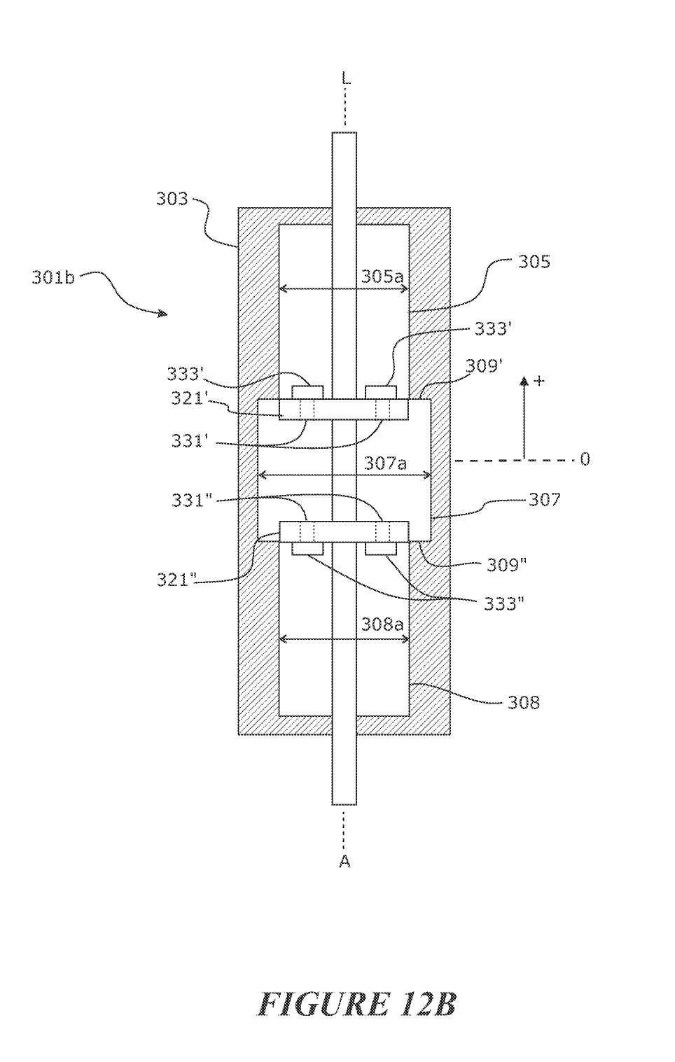

The particular described configurations of components are just one possible option, and modifications can be made to those configurations. FIG. 12A shows one possible alternative configuration of a 2-4 device 301a to that of FIGS. 6-9. Other than as described below, the features, functionality, and options for the following described embodiment 301a are as described above, and like reference numerals indicate like parts to the embodiment of FIGS. 6-9, with the addition of 200.

In this embodiment, the first chamber 305 and third chamber 308 are relatively small chambers and are positioned adjacent opposite ends of the device. The larger second chamber 307 is a middle or inner chamber located between the first and third chambers 305, 308, and has a relatively large internal transverse dimension 307a compared to the internal transverse dimensions 305a, 308a of the first chamber 305 and third chamber 308. In the form shown, the internal transverse dimensions 305a, 308a of the first and third chambers are substantially the same, and therefore the cross-section of the first chamber 305, the third chamber 308, the first piston 321′, and the second piston 321″ are substantially the same. Alternatively, the cross-section of the first chamber 305 and the first piston 321′ could differ from the cross-section of the third chamber 308 and the second piston 321″, as long as they are smaller than the cross-section of the second chamber 307.

The pistons 321′, 321″ could have the configuration described above with reference to FIG. 11.

The orientation of the one-way valves 333′ and 333″ on the first 321′ and second 321″ pistons is reversed compared with the embodiment shown in FIGS. 6 to 9.

Embodiments of the 1-3 device shown in FIG. 10 may also vary. For example, reversing the orientation of the one-way valves of the above configuration of a 2-4 device of FIG. 12A is a possible alternative configuration of a 1-3 device.

FIG. 12B shows one possible alternative configuration of a 1-3 device 301b to that of FIG. 10. Other than as described below, the features, functionality, and options for the following described embodiment are as described above, and like reference numerals indicate like parts to the embodiment of FIG. 12A.

In this embodiment, the orientation of the one-way valves 333′ and 333″ on the first 321′ and second 321″ pistons is reversed compared with the embodiment shown in FIG. 12A, so that the one-way valves operate in the opposite direction of movement of the pistons.

The above described embodiments have fluid passage(s) extending through the piston arrangement, with associated one-way valve(s) in or on the piston arrangement. Additionally, or alternatively, any of the seismic damper embodiments may comprise a fluid passage that is configured to allow fluid flow from one side of the piston to the other side of the piston, but which is not in the piston arrangement. The fluid passage will have at least one associated one-way valve, and may be provided at least partly in the wall and/or end cap of the cylinder. The fluid passage will, effectively, allow substantially free flow of the damping fluid through the fluid passage in a first direction of movement of the piston arrangement in the cylinder, and the damping fluid will be restricted from flowing through the fluid passage in a second direction of movement of the piston arrangement in the cylinder.

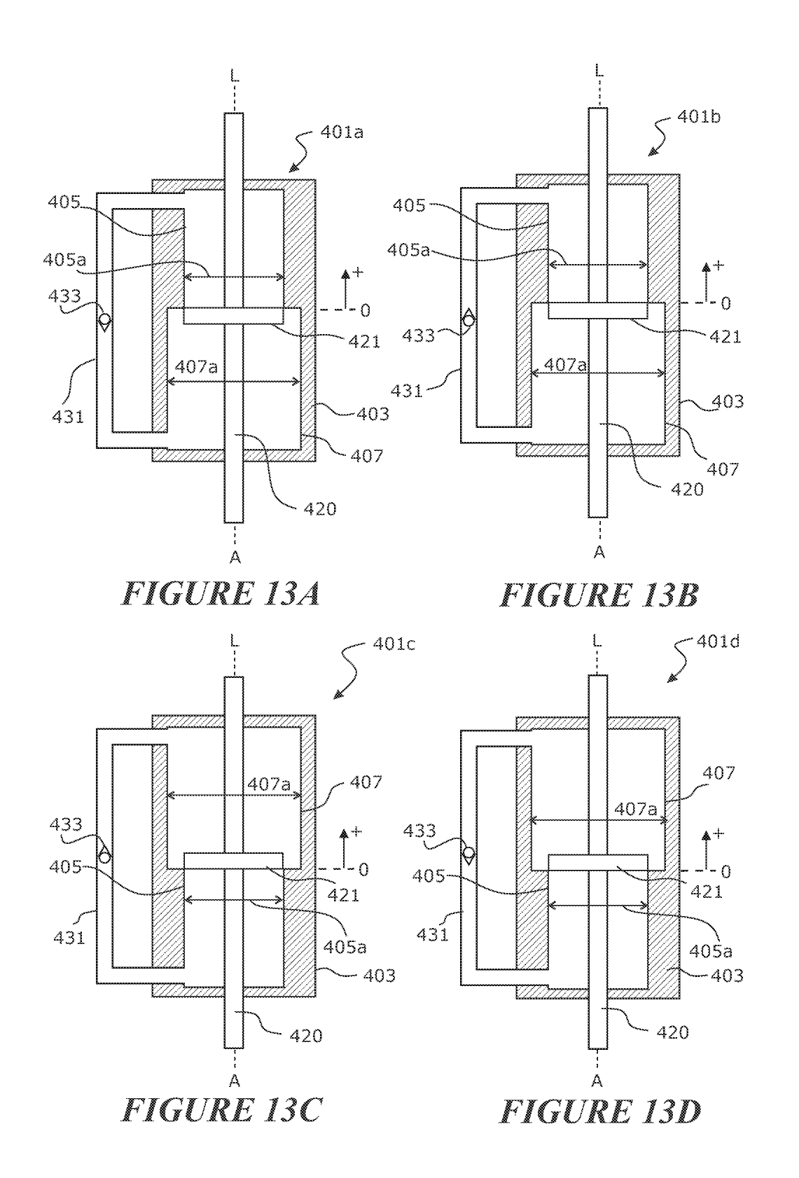

FIG. 13A shows one exemplary configuration for a passive seismic damper utilising such a fluid passage. Unless described below, the features, functionality, and options for the following described embodiment are as described above, and like reference numerals indicate like parts to those of FIGS. 1 and 5 with the addition of 400.

FIG. 13A shows a single quadrant device 401a that is configured to provide damping in the first quadrant of the hysteresis loop.

In this embodiment, rather than having a fluid passage 31 extending through the piston 21, the fluid passage 431 is part of the cylinder 403. The fluid passage 431 is in fluid communication with an orifice at or adjacent an outer end of the first chamber 405 and with an orifice at or adjacent an outer end of the second chamber 407. At least one one-way valve 433 is associated with the fluid passage, such as being provided in the fluid passage 431. A plurality of one-way valves may be provided in the fluid passage to provide a failsafe feature. Fluid can pass through the fluid passage from the second chamber 407 to the first chamber 405 such as when the piston 421 is moving in a negative direction in the cylinder, but cannot pass through the fluid passage from the first chamber 405 to the second chamber 407 such as when the piston 421 is moving in a positive direction in the cylinder.

Fluid can freely flow around the piston 421 when the piston is in the second chamber 407. The enlarged second chamber 407 and the periphery of the piston 421 provide a fluid passage in the device, with that fluid passage enabling the flow of fluid around the piston when it is in the second chamber. Depending on the relative sizes of the piston 421 and second chamber 407, and the force of the one-way valve 433, the one-way valve may be open during negative direction movement in the second chamber 407 or may be closed during that movement. The one-way valve 433 will be closed during positive movement of the piston 421 in the second chamber 407.

Fluid is restricted from flowing around the piston 421 when the piston is in the first chamber 405. The one way valve 433 will be closed during positive movement of the piston 421 in the first chamber 405, but will be open during negative movement of the piston 421 in the first chamber 405.

FIGS. 13B-D show further exemplary configurations for a passive seismic damper utilising a fluid passage with a one-way valve that is configured to allow fluid flow from one side of the piston to the other side of the piston, but which is not in the piston arrangement. Unless described below, the features, functionality, and options for the following described embodiment are as described above, and like reference numerals indicate like parts to those of FIG. 13A.

FIG. 13B shows a single quadrant device 401b that is configured to provide damping in the second quadrant of the hysteresis loop. Fluid can pass through the fluid passage from the first chamber 405 to the second chamber 407 such as when the piston 421 is moving in a positive direction in the cylinder, but cannot pass through the fluid passage from the second chamber 407 to the first chamber 405 such as when the piston 421 is moving in a negative direction in the cylinder.

Fluid can freely flow around the piston 421 when the piston is in the second chamber 407. The enlarged second chamber 407 and the periphery of the piston 421 provide a fluid passage in the device, with that fluid passage enabling the flow of fluid around the piston when it is in the second chamber. Depending on the relative sizes of the piston 421 and second chamber 407, and the force of the one-way valve 433, the one-way valve may be open during positive direction movement in the second chamber 407 or may be closed during that movement. The one-way valve 433 will be closed during negative movement of the piston 421 in the second chamber 407.

Fluid is restricted from flowing around the piston 421 when the piston is in the first chamber 405. The one way valve 433 will be closed during negative movement of the piston 421 in the first chamber 405, but will be open during positive movement of the piston 421 in the first chamber 405.

FIG. 13C shows a single quadrant device 401c that is configured to provide damping in the third quadrant of the hysteresis loop. Fluid can pass through the fluid passage from the second chamber 407 to the first chamber 405 such as when the piston 421 is moving in a positive direction in the cylinder, but cannot pass through the fluid passage from the first chamber 405 to the second chamber 407 such as when the piston 421 is moving in a negative direction in the cylinder.

Fluid can freely flow around the piston 421 when the piston is in the second chamber 407. The enlarged second chamber 407 and the periphery of the piston 421 provide a fluid passage in the device, with that fluid passage enabling the flow of fluid around the piston when it is in the second chamber. Depending on the relative sizes of the piston 421 and second chamber 407, and the force of the one-way valve 433, the one-way valve may be open during positive direction movement in the second chamber 407 or may be closed during that movement. The one-way valve 433 will be closed during negative movement of the piston 421 in the second chamber 407.

Fluid is restricted from flowing around the piston 421 when the piston is in the first chamber 405. The one way valve 433 will be closed during negative movement of the piston 421 in the first chamber 405, but will be open during positive movement of the piston 421 in the first chamber 405.

FIG. 13D shows a single quadrant device 401d that is configured to provide damping in the fourth quadrant of the hysteresis loop. Fluid can pass through the fluid passage from the first chamber 405 to the second chamber 407 such as when the piston 421 is moving in a negative direction in the cylinder, but cannot pass through the fluid passage from the second chamber 407 to the first chamber 405 such as when the piston 421 is moving in a positive direction in the cylinder.

Fluid can freely flow around the piston 421 when the piston is in the second chamber 407. The enlarged second chamber 407 and the periphery of the piston 421 provide a fluid passage in the device, with that fluid passage enabling the flow of fluid around the piston when it is in the second chamber. Depending on the relative sizes of the piston 421 and second chamber 407, and the force of the one-way valve 433, the one-way valve may be open during negative direction movement in the second chamber 407 or may be closed during that movement. The one-way valve 433 will be closed during positive movement of the piston 421 in the second chamber 407.

Fluid is restricted from flowing around the piston 421 when the piston is in the first chamber 405. The one way valve 433 will be closed during positive movement of the piston 421 in the first chamber 405, but will be open during negative movement of the piston 421 in the first chamber 405.

The device may have a plurality of the fluid passage 431 and associated one-way valve(s). The fluid passage(s) 431 may be provided instead of, or in addition to, the fluid passages through the piston arrangements.

The above described embodiments have chambers of different sizes so that there is substantially free flow of damping fluid around a piston when the piston is in a relatively large chamber, and so that damping fluid is restricted from flowing around the piston when the piston is in a relatively small chamber. Additionally, or alternatively, any of the seismic damper embodiments may comprise a fluid passage that is in fluid communication with one of the chambers via two orifices, the fluid passage configured to provide the substantial free flow of damping fluid around the piston when the piston is in the second chamber of the cylinder but to restrict flow of fluid around the piston when the piston is in the first chamber.

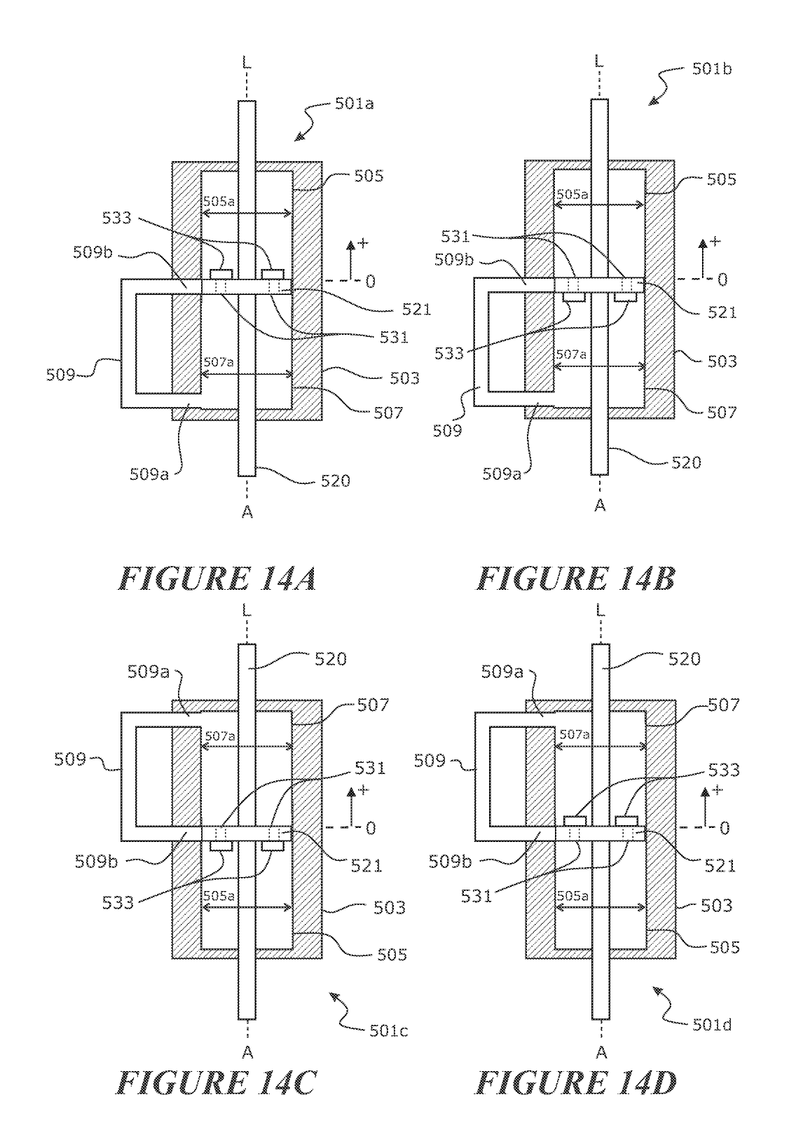

FIG. 14A shows one exemplary configuration for a passive seismic damper utilising such a fluid passage. Unless described below, the features, functionality, and options for the following described embodiment are as described above, and like reference numerals indicate like parts to those of FIGS. 1 and 5 with the addition of 500.

FIG. 14A shows a single quadrant device 501a that is configured to provide damping in the first quadrant of the hysteresis loop.

Rather than having chambers of different sizes with a transition region 9 between them, in this configuration the internal transverse dimensions 505a, 507a and sizes of the chambers can be the same as each other. Therefore, the first and second (and third if applicable) chambers can be formed by respective chamber portions of a main chamber. A fluid passage 509 that is at least partly positioned in the cylinder wall is in fluid communication with the second chamber 507 via two orifices 509a, 509b. One orifice 509a is located at or toward the outer end of the second chamber 507, and the other orifice 509b is located at an opposite end of the second chamber 507 adjacent the first chamber 505. The orifice 509b adjacent the first chamber 505 defines an intersection between the first chamber 505 and the second chamber 507. The orifice 509b may be provided at or toward a centre of the cylinder, or at any suitable position along the cylinder. The orifice 509a may be provided at least partly in a wall and/or end cap of the cylinder.

When the piston 521 is moving in the second chamber 507, and does not overlap either orifice, there is substantially free flow of fluid around the piston 521 through the orifices 509a, 509b and fluid passage 509. When the piston fully overlaps the orifice 509b, or is positioned in the first chamber 505 on the positive side of the orifice 509b, flow of fluid around the piston is restricted.

Depending on the relative sizes of the piston 521, and second chamber 507, the sizes of the orifices 509a, 509b and fluid passage 509, and the force of the one-way valve(s) 533, the one-way valve(s) may be open during negative direction movement in the second chamber 507 or may be closed during that movement. The one-way valve(s) 533 will be closed during positive movement of the piston 521 in the second chamber 507.

The one way valve(s) 533 will be closed during positive movement of the piston 521 in the first chamber 505, but will be open during negative movement of the piston 521 in the first chamber 505.

The cylinder may be provided with a plurality of the fluid passages 509.

FIGS. 14B-D show further exemplary configurations for a passive seismic damper utilising a fluid passage configured to provide the substantial free flow of damping fluid around the piston when the piston is in the second chamber of the cylinder but to restrict flow of fluid around the piston when the piston is in the first chamber. Unless described below, the features, functionality, and options for the following described embodiment are as described above, and like reference numerals indicate like parts to those of FIG. 14A.

FIG. 14B shows a single quadrant device 501b that is configured to provide damping in the second quadrant of the hysteresis loop. When the piston fully overlaps the orifice 509b, or is positioned in the first chamber 505 on the positive side of the orifice 509b, flow of fluid around the piston is restricted.

Depending on the relative sizes of the piston 521, and second chamber 507, the sizes of the orifices 509a, 509b and fluid passage 509, and the force of the one-way valve(s) 533, the one-way valve(s) may be open during positive direction movement in the second chamber 507 or may be closed during that movement. The one-way valve(s) 533 will be closed during negative movement of the piston 521 in the second chamber 507.

The one way valve(s) 533 will be closed during negative movement of the piston 521 in the first chamber 505, but will be open during positive movement of the piston 521 in the first chamber 505.

FIG. 14C shows a single quadrant device 501c that is configured to provide damping in the third quadrant of the hysteresis loop. When the piston fully overlaps the orifice 509b, or is positioned in the first chamber 505 on the negative side of the orifice 509b, flow of fluid around the piston is restricted.

Depending on the relative sizes of the piston 521, and second chamber 507, the sizes of the orifices 509a, 509b and fluid passage 509, and the force of the one-way valve(s) 533, the one-way valve(s) may be open during positive direction movement in the second chamber 507 or may be closed during that movement. The one-way valve(s) 533 will be closed during negative movement of the piston 521 in the second chamber 507.

The one way valve(s) 533 will be closed during negative movement of the piston 521 in the first chamber 505, but will be open during positive movement of the piston 521 in the first chamber 505.

FIG. 14D shows a single quadrant device 501d that is configured to provide damping in the fourth quadrant of the hysteresis loop. When the piston fully overlaps the orifice 509b, or is positioned in the first chamber 505 on the negative side of the orifice 509b, flow of fluid around the piston is restricted.

Depending on the relative sizes of the piston 521, and second chamber 507, the sizes of the orifices 509a, 509b and fluid passage 509, and the force of the one-way valve(s) 533, the one-way valve(s) may be open during negative direction movement in the second chamber 507 or may be closed during that movement. The one-way valve(s) 533 will be closed during positive movement of the piston 521 in the second chamber 507.

The one way valve(s) 533 will be closed during positive movement of the piston 521 in the first chamber 505, but will be open during negative movement of the piston 521 in the first chamber 505.

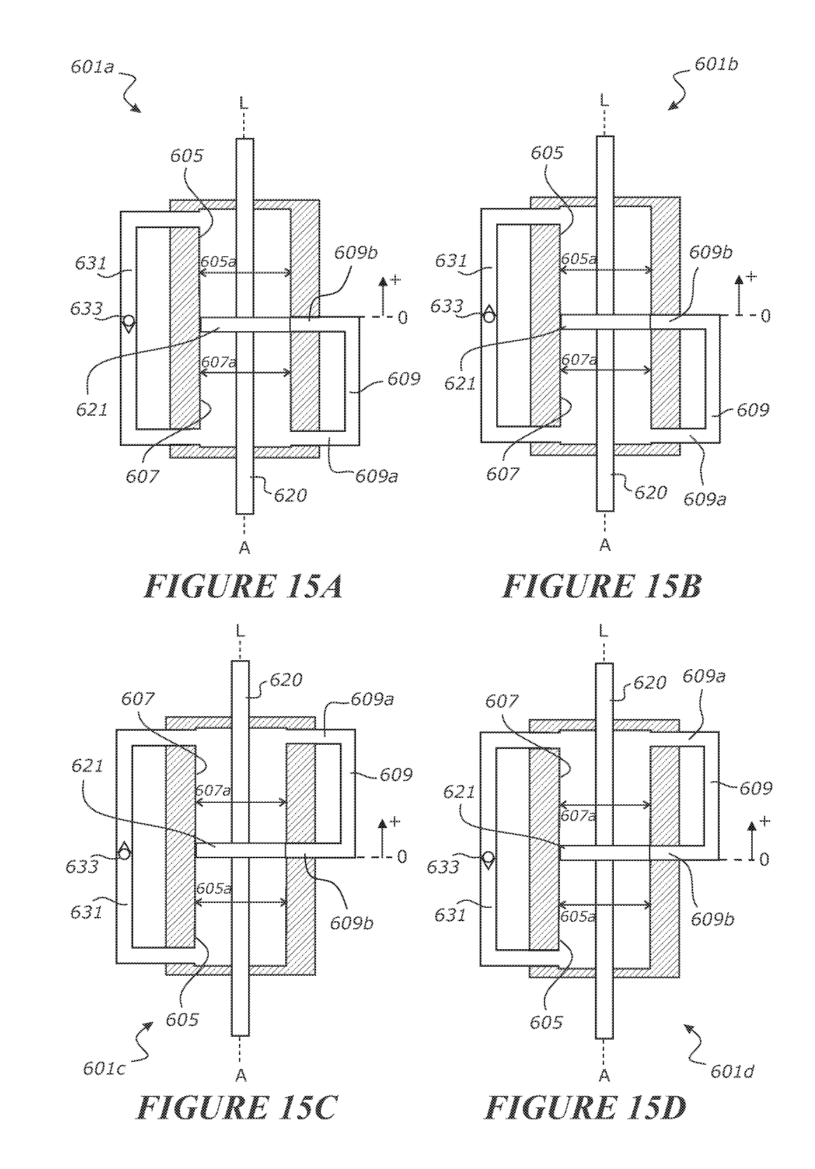

These features could also be provided in any suitable combination. FIG. 15A shows one exemplary configuration for a passive seismic damper utilising fluid passages similar to those described in relation to FIGS. 13A and 14A. Unless described below, the features, functionality, and options for the following described embodiment are as described above, and like reference numerals indicate like parts to those of FIGS. 13A and 14A, with the addition of 200 and 100 respectively.

FIG. 15A shows a single quadrant device 601a that is configured to provide damping in the first quadrant of the hysteresis loop.

As shown in this figure, the seismic damper does not have fluid passages or one-way valves in the piston arrangement. Nor does it have a stepped cylinder. Instead the seismic damper has fluid passage(s) 631 and one-way valve(s) 633 as described above with reference to FIG. 13A, and fluid passage(s) 609 and orifices 609a, 609b as described above with reference to FIG. 14A.

When the piston 621 is moving in the second chamber 607, and does not overlap either orifice, there is substantially free flow of fluid around the piston 621 through the orifices 609a, 609b and fluid passage 609. When the piston 621 fully overlaps the orifice 609b, or is positioned in the first chamber 605 on the positive side of the orifice 609b, flow of fluid around the piston is restricted.

Depending on the relative sizes of the piston 621, and second chamber 607, the sizes of the orifices 609a, 609b and fluid passage 609, and the force of the one-way valve(s) 633, the one-way valve(s) may be open during negative direction movement in the second chamber 607 or may be closed during that movement. The one-way valve(s) 633 will be closed during positive movement of the piston 621 in the second chamber 607.

The one way valve(s) 633 will be closed during positive movement of the piston 621 in the first chamber 605, but will be open during negative movement of the piston 621 in the first chamber 605.

FIGS. 15B-D show further exemplary configurations for a passive seismic damper utilising fluid passages similar to those described in relation to FIGS. 13B-D and 14B-D.

FIG. 15B shows a single quadrant device 601b that is configured to provide damping in the second quadrant of the hysteresis loop. The seismic damper has fluid passage(s) 631 and one-way valve(s) 633 as described above with reference to FIG. 13B, and fluid passage(s) 609 and orifices 609a, 609b as described above with reference to FIG. 14B.

When the piston 621 is moving in the second chamber 607, and does not overlap either orifice, there is substantially free flow of fluid around the piston 621 through the orifices 609a, 609b and fluid passage 609. When the piston 621 fully overlaps the orifice 609b, or is positioned in the first chamber 605 on the positive side of the orifice 609b, flow of fluid around the piston is restricted.

Depending on the relative sizes of the piston 621, and second chamber 607, the sizes of the orifices 609a, 609b and fluid passage 609, and the force of the one-way valve(s) 633, the one-way valve(s) may be open during positive direction movement in the second chamber 607 or may be closed during that movement. The one-way valve(s) 633 will be closed during negative movement of the piston 621 in the second chamber 607.

The one way valve(s) 633 will be closed during negative movement of the piston 621 in the first chamber 605, but will be open during positive movement of the piston 621 in the first chamber 605.

FIG. 15C shows a single quadrant device 601c that is configured to provide damping in the third quadrant of the hysteresis loop. The seismic damper has fluid passage(s) 631 and one-way valve(s) 633 as described above with reference to FIG. 13C, and fluid passage(s) 609 and orifices 609a, 609b as described above with reference to FIG. 14C.

When the piston 621 is moving in the second chamber 607, and does not overlap either orifice, there is substantially free flow of fluid around the piston 621 through the orifices 609a, 609b and fluid passage 609. When the piston 621 fully overlaps the orifice 609b, or is positioned in the first chamber 605 on the negative side of the orifice 609b, flow of fluid around the piston is restricted.

Depending on the relative sizes of the piston 621, and second chamber 607, the sizes of the orifices 609a, 609b and fluid passage 609, and the force of the one-way valve(s) 633, the one-way valve(s) may be open during positive direction movement in the second chamber 607 or may be closed during that movement. The one-way valve(s) 633 will be closed during negative movement of the piston 621 in the second chamber 607.

The one way valve(s) 633 will be closed during negative movement of the piston 621 in the first chamber 605, but will be open during positive movement of the piston 621 in the first chamber 605.

FIG. 15D shows a single quadrant device 601d that is configured to provide damping in the fourth quadrant of the hysteresis loop. The seismic damper has fluid passage(s) 631 and one-way valve(s) 633 as described above with reference to FIG. 13D, and fluid passage(s) 609 and orifices 609a, 609b as described above with reference to FIG. 14D.

When the piston 621 is moving in the second chamber 607, and does not overlap either orifice, there is substantially free flow of fluid around the piston 621 through the orifices 609a, 609b and fluid passage 609. When the piston 621 fully overlaps the orifice 609b, or is positioned in the first chamber 605 on the negative side of the orifice 609b, flow of fluid around the piston is restricted.

Depending on the relative sizes of the piston 621, and second chamber 607, the sizes of the orifices 609a, 609b and fluid passage 609, and the force of the one-way valve(s) 633, the one-way valve(s) may be open during negative direction movement in the second chamber 607 or may be closed during that movement. The one-way valve(s) 633 will be closed during positive movement of the piston 621 in the second chamber 607.

The one way valve(s) 633 will be closed during positive movement of the piston 621 in the first chamber 605, but will be open during negative movement of the piston 621 in the first chamber 605.

FIGS. 13A, 14A and 15A show these alternative features in single quadrant devices that are configured to provide damping in a first quadrant of the hysteresis loop. As outlined above, those devices may instead be configured to provide damping in the second, third, or fourth quadrant of the hysteresis loop by reversing the configuration of the one-way valve(s), the stepped cylinders, and/or the location of the fluid passage(s) 509, 609 as shown in FIGS. 13B-D, 14B-D, and 15B-D.

A skilled person would readily understand such configurations from reviewing the configurations described herein. Such devices could be provided in any of the configurations described herein. For example, two such devices could be installed in parallel to provide damping in diagonally opposed quadrants such as the 1-3 quadrants or the 2-4 quadrants.

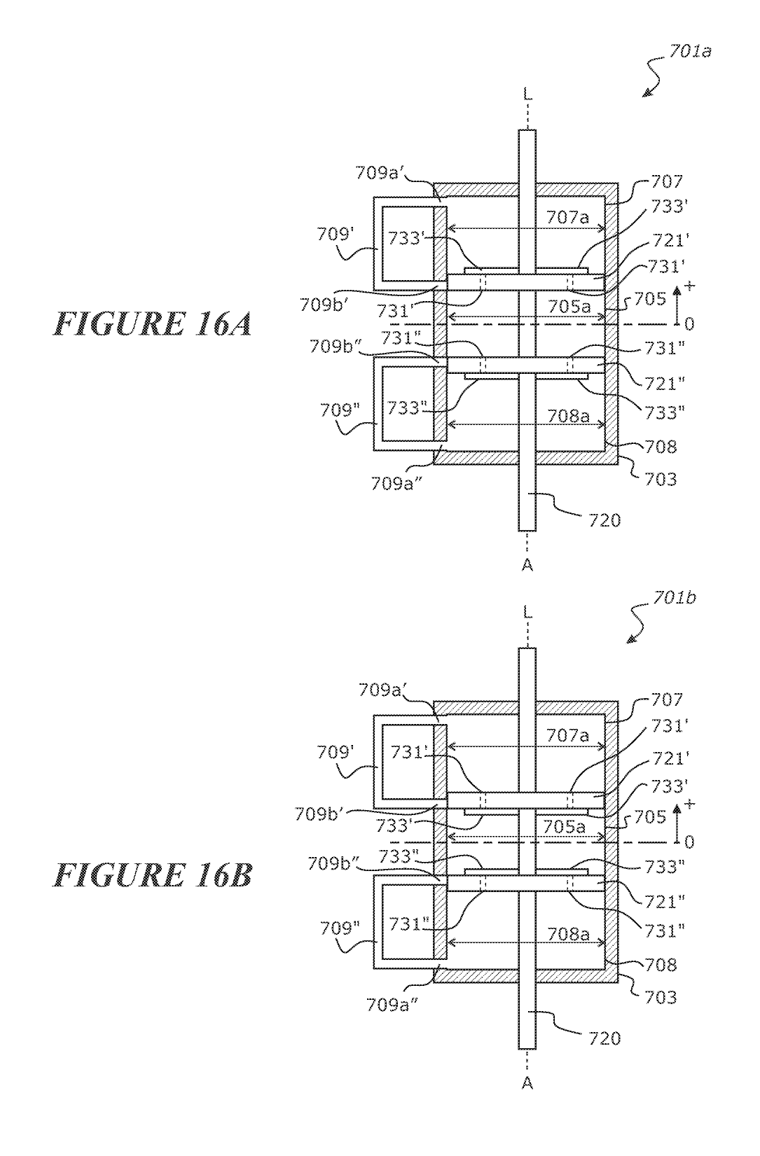

FIG. 16A shows an exemplary configuration of a device to provide damping in quadrant 2 and quadrant 4. The device is equivalent to the single quadrant devices of FIGS. 14B and 14D combined in parallel. Unless described below, the features, functionality, and options for the following described embodiment are as described above, and like reference numerals indicate like parts to those of FIGS. 9, 14B and 14D, with the addition of 600, 200 and 200 respectively, as well as prime (′) and double prime (″).

With reference to FIG. 16A, in addition to the features described above, the cylinder 703 of a preferred embodiment 2-4 device 701 comprises a third chamber 708 having a third internal transverse dimension. The third internal transverse dimension 708a can be the same as the first internal transverse dimension 705a of the first chamber and the second internal transverse dimension 707a of the second chamber. Therefore, the first, second and third chambers can be formed by respective chamber portions of a main chamber.

A first additional fluid passage 709′ is in fluid communication with the second chamber 707 via two orifices 709a′, 709b′. The first additional fluid passage 709′ is configured to provide the substantial free flow of damping fluid around the first piston 721′ when the first piston 721′ is in the second chamber 707 of the cylinder.

The first additional fluid passage 709′ that is configured to allow fluid flow from one side of the first piston 721′ to an opposite side of the first piston 721′, may be provided at least partly in a wall and/or an end cap of the cylinder.

One orifice 709a′ is located at or toward one end of the second chamber 707, and the other orifice 709b′ is located at an opposite end of the second chamber 707 adjacent the first chamber 705. The other orifice 709b′ defines an intersection between the first chamber 705 and the second chamber 707.

A second additional fluid passage 709″ is in fluid communication with the third chamber 708 via two orifices 709a″, 709b″. The second additional fluid passage 709″ is configured to provide the substantial free flow of damping fluid around the second piston 721″ when the second piston 721″ is in the third chamber 708 of the cylinder.

The second additional fluid passage 709″ that is configured to allow fluid flow from one side of the second piston 721″ to an opposite side of the second piston 721″, may be provided at least partly in a wall and/or an end cap of the cylinder.

One orifice 709a″ is located at or toward one end of the third chamber 708, and the other orifice 709b″ is located at an opposite end of the third chamber 708 adjacent the first chamber 705. The other orifice 709b″ defines an intersection between the first chamber 705 and the third chamber 708.

The orifices 709b′, 709b″ may be provided toward a centre of the cylinder, or at any suitable position along the cylinder. The orifices 709a′, 709a″ may be provided at least partly in a wall and/or end cap of the cylinder.

When the first piston 721′ is moving in the second chamber 707, and does not overlap either orifice, there is substantially free flow of fluid around the first piston 721′ through the orifices 709a′, 709b′ and fluid passage 709′. When the first piston 721′ fully overlaps the orifice 709b′, or is positioned in the first chamber 705 on the negative side of the orifice 709b′, flow of fluid around the piston is restricted.

When the second piston 721″ is moving in the third chamber 708, and does not overlap either orifice, there is substantially free flow of fluid around the second piston 721″ through the orifices 709a″, 709b″ and fluid passage 709″. When the second piston 721″ fully overlaps the orifice 709b″, or is positioned in the first chamber 705 on the positive side of the orifice 709b″, flow of fluid around the piston is restricted.

Depending on the relative sizes of the first piston 721′, the second chamber 707, the sizes of the orifices 709a′, 709b′ and fluid passage 709′, and the force of the one-way valve(s) 733′, the one-way valve(s) of the first piston 721′ may be open during negative direction movement of the first piston 721′ in the second chamber 707 or may be closed during that movement. The one-way valve(s) 733′ of the first piston 721′ will be closed during positive movement of the first piston 721′ in the second chamber 707.

The one way valve(s) 733′ of the first piston 721′ will be closed during positive movement of the first piston 721′ in the first chamber 705, but will be open during negative movement of the first piston 721′ in the first chamber 705.

Depending on the relative sizes of the second piston 721″, the third chamber 708, the sizes of the orifices 709a″, 709b″ and fluid passage 709″, and the force of the one-way valve(s) 733′″, the one-way valve(s) of the second piston 721″ may be open during positive direction movement of the second piston 721″ in the third chamber 708 or may be closed during that movement. The one-way valve(s) 733″ of the second piston 721″ will be closed during negative movement of the second piston 721″ in the third chamber 708.

The one way valve(s) 733″ of the second piston 721″ will be closed during negative movement of the second piston 721″ in the first chamber 705, but will be open during positive movement of the second piston 721″ in the first chamber 705.

FIG. 16B shows an exemplary configuration of a device to provide damping in quadrant 1 and quadrant 3. The device is equivalent to the single quadrant devices of FIGS. 14A and 14C installed in parallel. Unless described below, the features, functionality, and options for the following described embodiment are as described above, and like reference numerals indicate like parts to those of FIG. 16A.

The 1-3 device of FIG. 16B can be achieved by reversing the configuration of the one-way valves 733′, 733″ of the 2-4 device of FIG. 16A.

When the first piston 721′ is moving in the second chamber 707, and does not overlap either orifice, there is substantially free flow of fluid around the first piston 721′ through the orifices 709a′, 709b′ and fluid passage 709′. When the first piston 721′ fully overlaps the orifice 709b′, or is positioned in the first chamber 705 on the negative side of the orifice 709b′, flow of fluid around the piston is restricted.

When the second piston 721″ is moving in the third chamber 708, and does not overlap either orifice, there is substantially free flow of fluid around the second piston 721″ through the orifices 709a″, 709b″ and fluid passage 709″. When the second piston 721″ fully overlaps the orifice 709b″, or is positioned in the first chamber 705 on the positive side of the orifice 709b″, flow of fluid around the piston is restricted.

Depending on the relative sizes of the first piston 721′, the second chamber 707, the sizes of the orifices 709a′, 709b′ and fluid passage 709′, and the force of the one-way valve(s) 733′, the one-way valve(s) of the first piston 721′ may be open during positive direction movement of the first piston 721′ in the second chamber 707 or may be closed during that movement. The one-way valve(s) 733′ of the first piston 721′ will be closed during negative movement of the first piston 721′ in the second chamber 707.

The one way valve(s) 733′ of the first piston 721′ will be closed during negative movement of the first piston 721′ in the first chamber 705, but will be open during positive movement of the first piston 721′ in the first chamber 705.

Depending on the relative sizes of the second piston 721″, the third chamber 708, the sizes of the orifices 709a″, 709b″ and fluid passage 709″, and the force of the one-way valve(s) 733′″, the one-way valve(s) of the second piston 721″ may be open during negative direction movement of the second piston 721″ in the third chamber 708 or may be closed during that movement. The one-way valve(s) 733″ of the second piston 721″ will be closed during positive movement of the second piston 721″ in the third chamber 708.

The one way valve(s) 733″ of the second piston 721″ will be closed during positive movement of the second piston 721″ in the first chamber 705, but will be open during negative movement of the second piston 721″ in the first chamber 705.

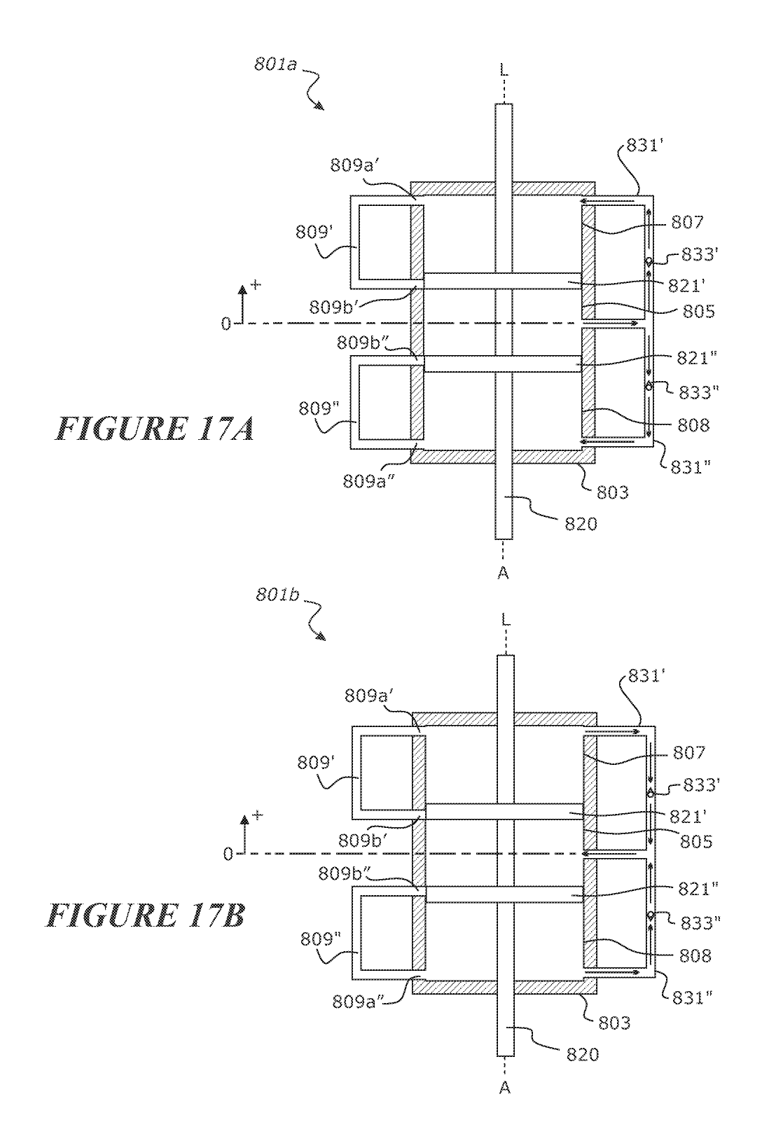

FIG. 17A shows an exemplary configuration device to provide damping in quadrant 2 and quadrant 4. The device is equivalent to the single quadrant devices of FIGS. 15B and 15D installed in parallel. Unless described below, the features, functionality, and options for the following described embodiment are as described above, and like reference numerals indicate like parts to those of FIGS. 9, 15B and 15D, with the addition of 700, 200 and 200 respectively, as well as prime (′) and double prime (″).

With reference to FIG. 17A, the 2-4 device 801 comprises fluid passages 831′, 831″ and one-way valves 833′, 833″ that are configured to allow fluid flow from one side of the piston to the other side of the piston, but which are not in the piston arrangement. Instead, the fluid passages are provided in a wall and/or end cap of the cylinder.

The fluid passage 831′ is in fluid communication with an orifice at or adjacent the neutral position 0 of the first chamber 805 and with an orifice at or adjacent an outer end of the second chamber 807. At least one one-way valve 833′ is associated with the fluid passage 831′, such as being provided in the fluid passage 831′. The fluid passage 831″ is in fluid communication with an orifice at or adjacent neutral position 0 the first chamber 805 and with an orifice at or adjacent an outer end of the third chamber 808. At least one one-way valve 833″ is associated with the fluid passage, such as being provided in the fluid passage 831″.

In the embodiment shown, the fluid passages 831′, 831″ are in fluid communication with the same orifice associated with the first chamber 805. In alternative embodiments, fluid passages 831′, 831″ may be in fluid communication with separate orifices associated with the first chamber 805. In some embodiments, the orifice(s) may be situated in the first chamber 805 at a location that is not at or adjacent the neutral position 0 of the first chamber 805. For example, the fluid passage 831′ may in fluid communication with an orifice at or adjacent the interface between the first chamber 805 and the third chamber 808, and/or the fluid passage 831″ may in fluid communication with an orifice at or adjacent the interface between the first chamber 805 and the second chamber 807.

When the first piston 821′ is moving in the second chamber 807, and does not overlap either orifice, there is substantially free flow of fluid around the first piston 821′ through the orifices 809a′, 809b′ and fluid passage 809′. When the first 821′ piston fully overlaps the orifice 809b′, or is positioned in the first chamber 805 on the negative side of the orifice 809b′, flow of fluid around the piston is restricted.

When the second piston 821″ is moving in the third chamber 808, and does not overlap either orifice, there is substantially free flow of fluid around the second piston 821″ through the orifices 809a″, 809b″ and fluid passage 809″. When the second piston 821″ fully overlaps the orifice 809b″, or is positioned in the first chamber 805 on the positive side of the orifice 809b″, flow of fluid around the piston is restricted.

Depending on the relative sizes of the first piston 821′, the second chamber 807, the sizes of the orifices 809a′, 809b′ and fluid passage 809′, and the force of the one-way valve 833′, the one-way valve 833′ may be open during negative direction movement of the first piston 821′ in the second chamber 807 or may be closed during that movement. The one-way valve(s) 833′ of the first piston 821′ will be closed during positive movement of the first piston 821′ in the second chamber 807.

The one way valve 833′ will be closed during positive movement of the first piston 821′ in the first chamber 805, but will be open during negative movement of the first piston 821′ in the first chamber 805.

Depending on the relative sizes of the second piston 821″, the third chamber 808, the sizes of the orifices 809a″, 809b″ and fluid passage 809″, and the force of the one-way valve 833′″, the one-way valve 833″ may be open during positive direction movement of the second piston 821″ in the third chamber 808 or may be closed during that movement. The one-way valve 833″ of the second piston 821″ will be closed during negative movement of the second piston 821″ in the third chamber 808.

The one way valve 833″ will be closed during negative movement of the second piston 821″ in the first chamber 805, but will be open during positive movement of the second piston 821″ in the first chamber 805.

FIG. 17B shows an exemplary configuration of a device to provide damping in quadrant 1 and quadrant 3. The device is equivalent to the single quadrant devices of FIGS. 15A and 15C installed in parallel. Unless described below, the features, functionality, and options for the following described embodiment are as described above, and like reference numerals indicate like parts to those of FIG. 17A.

The 1-3 device of FIG. 17B can be achieved by reversing the configuration of the one-way valves 733′, 733″ of the 2-4 device of FIG. 17A.

When the first piston 821′ is moving in the second chamber 807, and does not overlap either orifice, there is substantially free flow of fluid around the first piston 821′ through the orifices 809a′, 809b′ and fluid passage 809′. When the first piston 821′ fully overlaps the orifice 809b′, or is positioned in the first chamber 805 on the negative side of the orifice 809b′, flow of fluid around the piston is restricted.

When the second piston 821″ is moving in the third chamber 808, and does not overlap either orifice, there is substantially free flow of fluid around the second piston 821″ through the orifices 809a″, 809b″ and fluid passage 809″. When the second piston 821″ fully overlaps the orifice 809b″, or is positioned in the first chamber 805 on the positive side of the orifice 809b″, flow of fluid around the piston is restricted.

Depending on the relative sizes of the first piston 821′, the second chamber 807, the sizes of the orifices 809a′, 809b′ and fluid passage 809′, and the force of the one-way valve 833′, the one-way valve 833′ may be open during positive direction movement of the first piston 821′ in the second chamber 807 or may be closed during that movement. The one-way valve(s) 833′ of the first piston 821′ will be closed during negative movement of the first piston 821′ in the second chamber 807.

The one way valve 833′ will be closed negative movement of the first piston 821′ in the first chamber 805, but will be open during positive movement of the first piston 821′ in the first chamber 805.

Depending on the relative sizes of the second piston 821″, the third chamber 808, the sizes of the orifices 809a″, 809b″ and fluid passage 809″, and the force of the one-way valve 833′″, the one-way valve 833″ may be open during negative direction movement of the second piston 821″ in the third chamber 808 or may be closed during that movement. The one-way valve 833″ of the second piston 821″ will be closed during positive movement of the second piston 821″ in the third chamber 808.

The one way valve 833″ will be closed during positive movement of the second piston 821″ in the first chamber 805, but will be open during negative movement of the second piston 821″ in the first chamber 805.

As outlined in embodiments above, the devices that utilise fluid passages such as 509, 609, 709′, 709″, 809′, 809″ could be arranged to have the orifices 509b, 609b, 709b′, 709b″, 809b′, 809b″ offset relative to the neutral position of the piston 521, 621, 721′, 721″, 821′, 821″ in the cylinder, to provide damping in a quadrant and in a portion of an adjacent quadrant of a hysteresis loop.

Fluid passages similar to passages 431, 631 with one-way valve(s), and/or fluid passages similar to passages 509, 609 could be provided in diagonally opposed-quadrant devices such as those described with reference to 7A to 9, 10, or 12, either in addition to the stepped cylinders and fluid passage(s) and one-way valve(s) in the piston arrangements, or as an alternative to one or more of those features.

The preferred embodiments described herein provide passive dampers that provide damping only for certain direction(s) or part(s) of motion. The devices are robust and require minimal maintenance and oversight, and are significantly less expensive to produce than active dampers or semi-active dampers.

A plurality of the described embodiments could be used in combination to provide functionality similar to a resettable semi-active damper, thereby providing a force/displacement response that does not increase demand on the items being damped, dissipates energy on every cycle instead of relying on structural yielding and damage, and provides more optimal and better controlled base isolation to avoid structural failures, to separate the energy dissipation mechanism from structural motion and damage.

Preferred embodiments of the invention have been described by way of example only and modifications may be made thereto without departing from the scope of the invention.

The figures and described embodiments show some possible fluid passage configurations, but any suitable configuration could be used. For example, where single pipes or passages are shown, a plurality of passages could be provided.

The described embodiments have piston arrangements and chambers configured so that damping fluid substantially freely flows around the piston when the piston is in the second chamber (for a single piston device) or so that the damping fluid substantially freely flows around the respective piston when the piston is in one chamber and the damping fluid is restricted from flowing around the respective piston when the piston is in another chamber (for a dual piston device). That provides little or no damping of the piston when the piston is in the respective chamber. Alternatively, any of the described embodiments could be configured so that the damping fluid relatively freely flows around the piston when the piston is in the second chamber (for the single piston device) or so that the damping fluid relatively freely flows around the respective piston when the piston is in another chamber (for the dual piston device), without the flow necessarily being substantially free flow. That is, the flow will still be freer than in the more restrictive chamber, but may not be substantially free flow around the piston. In that configuration, the device will provide less damping of the piston in the respective chamber than in the other chamber, but may not provide little or no damping of the piston in the respective chamber.

The freeness/restriction of fluid flow may readily configured by providing large chambers (e.g. 7, 107, 108, 207, 208, 307, 407) that are closer in size to the small chambers (e.g. 5, 105, 205, 305, 308, 405) than those shown in the figures, so damping fluid flow around the pistons is more restricted in those large chambers than for the embodiments shown in the figures, while still being less restricted than fluid flow around the pistons in the small chambers. Similarly, for embodiments that utilise fluid passages 509, 609, 709′, 709″, 809′, 809″ to provide fluid flow around the pistons, one or more of the orifices 509a, 509b, 609a, 609b, 709a′ 709b′, 709a″, 709b″, 809a′, 809b′, 809a″, 809b″ or fluid passages may be made larger to provide more free flow of fluid and thereby reduced damping, or may be made smaller to provide less free flow of fluid and thereby increased damping, relative to the configuration shown in the figures. For example, by varying the dimensions of the chambers, orifices, and/or fluid passages, the damping of movement of the respective piston in the chamber 7, 107, 108, 207, 208, 307, 407, 507, 607, 707, 708, 807, 808 may be less than about ⅔, optionally less than about ½, optionally less than about ¼, or optionally any suitable reduced amount of the damping of movement of the piston in chamber 5, 105, 205, 305, 308, 405, 505, 605, 705, 805. Similarly, the diagonally opposed quadrant devices may be configured to provide different levels of damping in each of chambers 107, 108, 207, 208, 305, 308, 405, 407, 505, 507, 605, 607, 707, 708 through selection of different dimensions of chambers, orifices, and/or fluid passages.

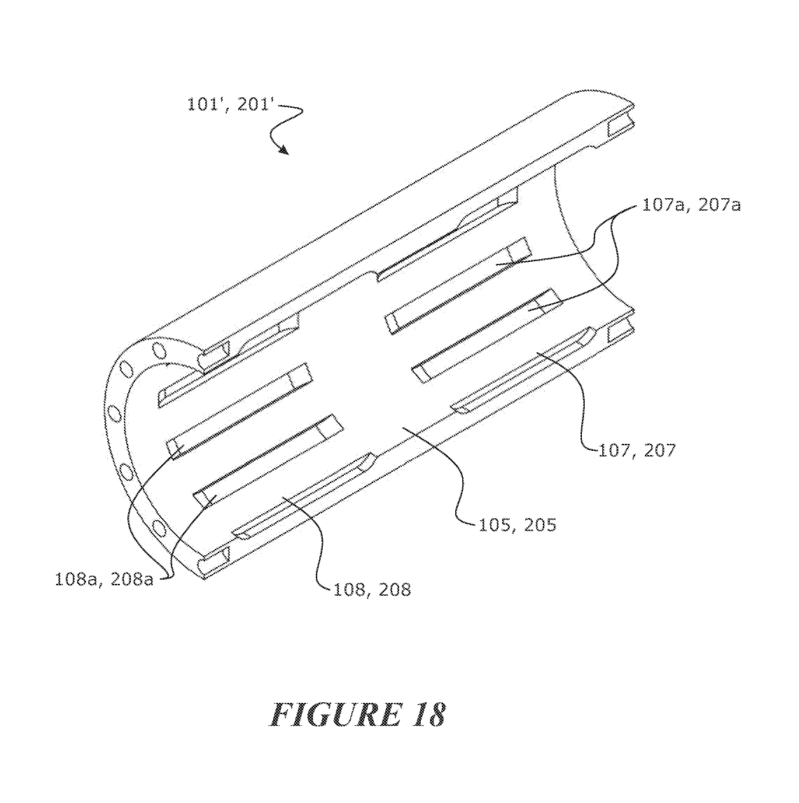

The dampers are described has having differently-sized chambers with a relatively large dimension and a relatively small dimension, to provide relatively or substantially free flow of fluid around the piston when the piston is in one chamber and to restrict the flow of fluid around the piston when the piston is in another chamber. Rather than having substantially the entire chamber with the larger dimension being a larger size than the chamber with the smaller dimension, discrete part(s) of that chamber may be larger. For example, FIG. 18 shows an example of an alternative configuration cylinder 107′, 207′ that may be used in the dampers of FIG. 9 or 10. In this configuration, the cylinder 107′, 207′ has at least one, and optionally a plurality of, axially extending slots 107a, 207a, 108a, 208a. The slots 107a, 207a, 108a, 208a may be relatively evenly angularly spaced around the walls of the chambers 107, 207, 108, 208. The slots 107a, 207a, 108a, 208a define the chambers 107, 207, 108, 208 having the relatively large dimension, with opposed slots having a larger diameter than portions of the walls between the splines 107a, 207a, 108a, 208a. The slots provide fluid passages in the walls of the cylinder to enable damping fluid to flow around the piston, through the slots 107a, 207a, 108a, 208a, when the piston 121′, 121″, 221′, 221″ is adjacent the slots. The chamber 105, 205 without the slots restricts flow of fluid around the piston when the piston 121′, 121″, 221′, 221″ is in that chamber 105, 205.

The chamber walls, other than the slots 107a, 207a, 108a, 208a, are advantageously a constant diameter or transverse dimension along the length of the cylinder, to assist with keeping the piston(s) centred and engaged with the chamber walls during movement of the piston(s) in and between the chambers.

Any of the embodiments described herein could have slot(s) to provide the flow of fluid around the piston(s), rather than the described configurations of differently-sized chambers or fluid passages in walls and/or end caps of the cylinder.

The specification describes providing dampers in combination in parallel. Alternatively, the dampers may be arranged in series. The dampers may be arranged together or co-located, or may be arranged at different ends of a brace or tendon. Two or more devices could be arranged immediately adjacent to one another, or spaced out within a structure.

The devices could be arranged in any other way such that they undergo the same device input displacement.

Depending on the combination of devices used, the devices in accordance with the described embodiments could be used to control one, two, three, or four quadrants of motion.

The single quadrant devices can be designed with either smooth or sharp transitions around the centre or neutral position of the device. For example, for embodiments having stepped cylinders, the transition from a smaller to larger chamber may be sharp, or may be provided by a more gradual angled transition region.

With use of the described embodiment devices as seismic dampers, low-to-no damage structures may be ready for occupancy and immediate use immediately after a major seismic event.

The preferred embodiment devices may be used alone, in combination with other preferred embodiment devices, and/or in combination with other seismic dampers. For example, the device(s) could be used in combination with ROGLIDER seismic isolators (a product from Robinson Seismic Limited in Wellington, New Zealand) or similar devices, such that one device provides resistance and dissipation and the other device provides substantially free motion.

1-6. (canceled)

7. A passive damper for providing damping of a first item relative to a second item, the damper comprising:
a cylinder that is arranged to be operatively connected to a first item, the cylinder having a longitudinal direction and comprising a first chamber, a second chamber, and a third chamber;
a piston arrangement that is arranged to be operatively connected to a second item, the piston arrangement comprising a first piston coupled to a second piston to move with the second piston, wherein the first and second pistons are movable in the longitudinal direction in the cylinder, the pistons configured such that each piston can move between two chambers;
a first fluid passage that is configured to allow fluid flow from one side of the first piston to an opposing side of the first piston, a second fluid passage that is configured to allow fluid flow from one side of the second piston to an opposing side of the second piston, and one-way valves associated with the fluid passages; and
damping fluid in the cylinder;
wherein one of the one-way valves is configured so that the damping fluid is restricted from flowing through its associated fluid passage in a first direction of movement of the piston arrangement in the cylinder and the other of the one-way valves is configured so that the damping fluid is restricted from flowing through its associated fluid passage in a second direction of movement of the piston arrangement in the cylinder; and
wherein the pistons and chambers are configured so that damping fluid relatively freely flows around the respective piston when the piston is in one chamber and the damping fluid is restricted from flowing around the respective piston when the piston is in another chamber.

8. The damper according to claim 7, wherein the pistons and chambers are configured so that damping fluid substantially freely flows around the respective piston when the piston is in one chamber.

9-18. (canceled)

19. The damper according to claim 7, wherein:
the piston arrangement comprises the first fluid passage, the second fluid passage, and the associated one-way valves, wherein the first fluid passage passes from one side of the first piston that corresponds to the first direction of movement to an opposing side of the first piston that corresponds to the second direction of movement, wherein the second fluid passage passes from one side of the second piston that corresponds to the first direction of movement to an opposing side of the second piston that corresponds to the second direction of movement;
and
wherein either a middle one of the chambers has a larger internal dimension and two outer ones of the chambers have smaller internal dimensions, or a middle one of the chambers has a smaller internal dimension and two outer ones of the chambers have larger internal dimensions, and wherein the pistons and chambers are configured so that damping fluid relatively freely or substantially freely flows around the respective piston when the piston is in a chamber having a larger internal dimension and the damping fluid is restricted from flowing around the respective piston when the piston is in a chamber having a smaller internal dimension.

20. (canceled)

21. The damper according to claim 19, wherein the cylinder chambers and one-way valves are configured so that damping occurs in two diagonally opposite quadrants of a force-displacement hysteresis loop.

22. The damper according to claim 21, wherein the cylinder chambers and one-way valves are configured so that damping occurs in quadrant 1 and quadrant 3 of the force-displacement hysteresis loop.

23. The damper according to claim 21, wherein the cylinder chambers and one-way valves are configured so that damping occurs in quadrant 2 and quadrant 4 of the force-displacement hysteresis loop.

24-48. (canceled)

49. A passive damper for providing damping of a first item relative to a second item, the damper comprising:
a cylinder that is arranged to be operatively connected to a first item, the cylinder having a first chamber, a second chamber, and a third chamber;
a first piston coupled to a second piston to move with the second piston, the first and second pistons arranged to be operatively connected to a second item, the pistons being movable in the cylinder;
a first fluid passage that is configured to allow fluid flow from one side of the first piston to an opposite side of the first piston, the first fluid passage associated with a one-way valve;
a second fluid passage that is configured to allow fluid flow from one side of the second piston to an opposite side of the second piston, the second fluid passage associated with a one-way valve;
and damping fluid in the cylinder;
wherein the damper is configured so that damping occurs in two diagonally opposite quadrants of a force-displacement hysteresis loop and less damping occurs in the other two quadrants of the hysteresis loop, or so that damping occurs in two diagonally opposite quadrants of the hysteresis loop and in a portion of each of the adjacent quadrants of the hysteresis loop and less damping occurs in a remainder of each of the adjacent quadrants of the hysteresis loop.

50. The damper according to claim 49, configured so that damping fluid relatively freely flows around the first piston when the first piston is in the second chamber of the cylinder and the damping fluid is restricted from flowing around the first piston when the piston is in the first chamber of the cylinder, and configured so that damping fluid relatively freely flows around the second piston when the second piston is in the third chamber of the cylinder and the damping fluid is restricted from flowing around the second piston when the second piston is in the first chamber.

51. The damper according to claim 50, comprising a first additional fluid passage that is in fluid communication with the second chamber via two orifices, the first additional fluid passage configured to provide the relatively free flow of damping fluid around the first piston when the first piston is in the second chamber of the cylinder; and wherein one orifice is located at or toward one end of the second chamber, and the other orifice is located at an opposite end of the second chamber adjacent the first chamber, with the other orifice defining an intersection between the first chamber and the second chamber; and wherein the damper comprises a second additional fluid passage that is in fluid communication with the third chamber via two orifices, the second additional fluid passage configured to provide the relatively free flow of damping fluid around the second piston when the second piston is in the third chamber of the cylinder; and wherein one orifice of the second additional fluid passage is located at or toward one end of the third chamber, and the other orifice of the second additional fluid passage is located at an opposite end of the third chamber adjacent the first chamber, with the other orifice of the second additional fluid passage defining an intersection between the first chamber and the third chamber.

52-54. (canceled)

55. The damper according to claim 50, configured so that the damping fluid substantially freely flows around the first piston when the first piston is in the second chamber and so that damping fluid substantially freely flows around the second piston when the second piston is in the third chamber.

56. The damper according to claim 49, wherein the first fluid passage and the second fluid passage are provided at least partly in a wall and/or an end cap of the cylinder.

57. The damper according to claim 49, wherein the first fluid passage and the second fluid passage are provided in the pistons.

58. The passive damper according to claim 49, wherein:
the first chamber has a first internal transverse dimension, the second chamber has a second internal transverse dimension, and the third chamber has a third internal transverse dimension, wherein at least one chamber has a larger internal transverse dimension than at least one other chamber; and
the first fluid passage is provided in the first piston and the second fluid passage is provided in the second piston.

59. The damper according to claim 49, wherein the cylinder chambers and one-way valves are configured so that damping occurs in quadrant 1 and quadrant 3 of the hysteresis loop; and either
the cylinder chambers and piston are configured so that damping also occurs in a portion of each of quadrant 2 and quadrant 4 of the hysteresis loop and less damping occurs in a remainder of quadrant 2 and quadrant 4 of the hysteresis loop,
or
the cylinder chambers and piston are configured so that less damping occurs in quadrant 2 and quadrant 4 of the hysteresis loop.

60. The damper according to claim 59, configured so that little or no damping occurs in the remainder of quadrant 2 and quadrant 4 of the hysteresis loop, or little or no damping occurs in quadrant 2 and quadrant 4 of the hysteresis loop.

61. The damper according to claim 49, wherein the cylinder chambers and one-way valves are configured so that damping occurs in quadrant 2 and quadrant 4 of the hysteresis loop; and either
the cylinder chambers and piston are configured so that damping also occurs in a portion of each of quadrant 1 and quadrant 3 of the hysteresis loop and less damping occurs in a remainder of quadrant 1 and quadrant 3 of the hysteresis loop,
or
the cylinder chambers and piston are configured so that less damping occurs in quadrant 1 and quadrant 3 of the hysteresis loop.

62. The seismic damper according to claim 61, configured so that little or no damping occurs in the remainder of quadrant 1 and quadrant 3 of the hysteresis loop, or little or no damping occurs in quadrant 1 and quadrant 3 of the hysteresis loop.

63. A damper according to claim 7, wherein the damper is a seismic damper.

64. A damper according to claim 22, wherein either:
the middle one of the chambers has a perimeter gap around the pistons allowing relatively free or substantially free flow of the damping fluid around the pistons when in that chamber, and the outer ones of the chambers have substantially no perimeter gap allowing little or no flow of the damping fluid around the pistons when in those chambers; and each one-way valve is configured to restrict flow of the damping fluid through its associated fluid passage during movement of the respective piston in a direction away from a centre of the cylinder, and is configured to enable flow of the damping fluid through its associated fluid passage during movement of the respective piston in a direction toward a centre of the cylinder; or
the middle one of the chambers has substantially no perimeter gap around the pistons allowing little or no flow of the damping fluid around the pistons when in that chamber, and the outer ones of the chambers have a perimeter gap around the pistons allowing relatively free or substantially free flow of the damping fluid around the pistons when in those chambers; and each one-way valve is configured to restrict flow of the damping fluid through its associated fluid passage during movement of the respective piston in a direction away from a centre of the cylinder, and is configured to enable flow of the damping fluid through its associated fluid passage during movement of the respective piston in a direction toward a centre of the cylinder.

65. A damper arrangement according to claim 64, wherein the pistons comprise one or more fluid passages that are permanently open.

66. A damper according to claim 23, wherein either:
the middle one of the chambers has a perimeter gap around the pistons allowing relatively free or substantially free flow of the damping fluid around the pistons in when in that chamber, and the outer ones of the chambers have substantially no perimeter gap allowing little or no flow of the damping fluid around the pistons when in those chambers; and each one-way valve is configured to restrict flow of the damping fluid through its associated fluid passage during movement of the respective piston in a direction toward a centre of the cylinder, and is configured to enable flow of the damping fluid through its associated fluid passage during movement of the respective piston in a direction away from a centre of the cylinder; or
the middle one of the chambers has substantially no perimeter gap around the pistons allowing little or no flow of the damping fluid around the pistons when in that chamber, and the outer ones of the chambers have a perimeter gap around the pistons allowing relatively free or substantially free flow of the damping fluid around the pistons when in those chambers; each one-way valve is configured to restrict flow of the damping fluid through its associated fluid passage during movement of the respective piston in a direction toward a centre of the cylinder, and is configured to enable flow of the damping fluid through its associated fluid passage during movement of the respective piston in a direction away from a centre of the cylinder.

67. A damper according to claim 66, wherein the pistons comprise one or more fluid passages that are permanently open.

68. A passive damper for providing damping of a first item relative to a second item, the damper comprising:
a cylinder that is arranged to be operatively connected to a first item, the cylinder having a longitudinal direction and comprising a first end chamber, a middle chamber, and a second end chamber;
a piston arrangement that is arranged to be operatively connected to a second item, the piston arrangement comprising a first piston coupled to a second piston to move with the second piston, wherein the first and second pistons are movable in the longitudinal direction in the cylinder, the pistons configured such that each piston can move between two of the chambers, each piston having a fluid passage and an associated one-way valve, wherein the one-way valve of one piston is configured to restrict fluid flow through the respective passage in an opposite direction of movement of the piston arrangement in the cylinder than the one-way valve of the other piston;
and either the middle chamber has a perimeter gap around the pistons allowing relatively free or substantially free flow of damping fluid around the pistons when in the middle chamber, and the first and second end chambers have substantially no perimeter gap allowing little or no flow of damping fluid around the pistons when in those end chambers, or the middle chamber has substantially no perimeter gap around the pistons allowing little or no flow of damping fluid around the pistons when in the middle chamber, and the first and second end chambers have a perimeter gap around the pistons allowing relatively free or substantially free flow of damping fluid around the pistons when in those end chambers; and
damping fluid in the cylinder;
wherein one of the one-way valves is configured so that the damping fluid is restricted from flowing through its associated fluid passage in a first direction of movement of the piston arrangement in the cylinder and the other of the one-way valves is configured so that the damping fluid is restricted from flowing through its associated fluid passage in the second direction of movement of the piston arrangement in the cylinder; and
wherein the pistons and chambers are configured so that damping fluid relatively freely or substantially freely flows via the perimeter gap around the respective piston when the piston is in the chamber having a perimeter gap and little or no damping fluid flows around the respective piston when the piston is the chamber having substantially no perimeter gap.
